(19) United States
(12) Patent Application Publication
(10) Pub. No.: US 2013/0132110 A1
(43) Pub. Date: May 23, 2013

(54) DEMENTIA CARE SUPPORT METHOD, DEMENTIA INFORMATION OUTPUT APPARATUS, AND DEMENTIA CARE SUPPORT SYSTEM

(71) Applicant: Sharp Kabushiki Kaisha, Osaka (JP)

(72) Inventors: Ayae Nagaoka, Osaka-shi (JP); Ichiko Sata, Osaka-shi (JP)

(73) Assignee: SHARP KABUSHIKI KAISHA, Osaka (JP)

(21) Appl. No.: 13/666,327

(22) Filed: Nov. 1, 2012

(30) Foreign Application Priority Data
Nov. 22, 2011 (JP) 2011-255434

(51) Int. Cl. G06Q 50/22

(52) U.S. Cl. 705/2

(57) ABSTRACT

A plurality of kinds of questions related to a patient of dementia is displayed on a first communication apparatus, the answers to the questions are inputted to the first communication apparatus, and patient condition information based on the inputted answers is stored at a server. Further, a graphical representation chronologically representing a plurality of pieces of patient condition information and a graphical representation representing a plurality of kinds of patient condition information so as to be associated with each other are generated at the server. The generated graphical representations are displayed on a second communication apparatus. A caregiver, a doctor or the like grasps a symptom of the patient and a change of the symptom based on the displayed graphical representations.

### CROSS-REFERENCE TO RELATED APPLICATIONS

This Non-provisional application claims priority under 35 U.S.C.§119(a) on Patent Application No. 2011-255434 filed in Japan on Nov. 22 2011, the entire contents of which are hereby incorporated by reference.

### FIELD

The present invention relates to a dementia care support method, a dementia information output apparatus and a dementia care support system for supporting the care and treatment of a dementia patient.

BACKGROUND

It is said that one in four people aged 85 or over has dementia, and with the advent of the super-aging society, it is speculated that the number will double in the next twenty years. However, dementia is never cured completely, and the psychological and physical burden on patients and caregivers is extremely heavy. Therefore, it is desired to support the care and treatment of dementia patients so that the progression of dementia is delayed, that the patients recover confidence and pride and that both the patients and the caregivers live a healthy life.

Conventionally, a technology for supporting the care and treatment of patients has been proposed. In a dementia examination support system described in Japanese Patent Application Laid-Open No. 2010-259634, information necessary for carrying out the dementia examination is displayed on an apparatus used by a health care professional (for example, a doctor) who carries out the dementia examination. Consequently, by carrying out the dementia examination according to the displayed information, the health care professional can easily obtain accurate examination results. Moreover, by accumulating the examination results in the dementia examination support system and displaying the accumulated examination results together with the examination execution dates, the health care professional can learn the chronological changes of the examination results.

In a medical information management apparatus described in Japanese Patent Application Laid-Open No. 2010-117969, the biological information of the patient is measured, and when the measurement result is outside a predetermined range, a list of doctors who can examine the patient is displayed on a portable terminal used by the nurse. Consequently, the nurse can quickly contact the doctor who should examine the patient whose condition has been changed.

In a dementia patient observation system described in Japanese Patent Application Laid-Open No. 2008-113720, when the caregiver inputs information on the daily life of the dementia patient to the portable terminal of the caregiver, the inputted information is accumulated, and the accumulated information is displayed on the portable terminal of a health care professional (for example, a doctor, or a medical representative of a pharmaceutical company). Consequently, the health care professional can easily learn the condition of the daily life of the patient from the past up to the present.

Hereinafter, a person concerned with the care and treatment of a patient, such as a caregiver or a doctor for the patient, will sometimes be referred to as a care concerned person without any distinction.

### SUMMARY

At the care and treatment sites, it is necessary to appropriately perform the care and treatment of the patient, the formulation of a care plan or the like according to the symptoms of the patient and the changes of the symptoms. However, dementia is a disease that is comparatively slow in progression. In addition, its symptoms are largely dependent on the environment where the patient is. For example, there are cases where a symptom that appears when the patient is at home, a care facility or the like does not appear when the doctor examines the patient at a hospital. Therefore, to accurately grasp the symptoms of the patient and the changes of the symptoms, it is desirable to refer to a care record describing the everyday condition of the patient over a long period of time (for example, half a year or longer, or one year or longer). Further, it is desirable that this care record include not only the results of the cognitive function examination and the results of measurement of the biological information (the blood pressure, the weight, etc.) of the patient but also the results of observation of core symptoms (that is, amnesia, disorientation, agnosia, apraxia and aphasia) caused by dementia and peripheral symptoms (specifically, mental symptoms such as uneasiness, depression, hallucination and delusion, and behavioral symptoms such as wandering and filthy acts) that appear along with the core symptoms. As a result of the above, the amount of care record information is enormous.

It is not easy even for an expert such as a doctor to understand an enormous amount of information in a short time and accurately determine the contents and degrees of the symptoms and the contents and degrees of changes of the symptoms. Moreover, it is desirable that the care planner who designs the care plan, the community general support center staff who introduces a care facility, the care worker and the family of the patient who actually care the patient, and the like also grasp the symptoms of the patient and the changes of the symptoms. Therefore, a technology is demanded of supporting the grasp of the symptoms of the patient and the changes of the symptoms by the care concerned person.

However, the dementia examination support system described in Japanese Patent Application Laid-Open No. 2010-259634 is a system the main focus of which is to support the execution of the dementia examination. The medical information management apparatus described in Japanese Patent Application Laid-Open No. 2010-117969 is an apparatus intended for shortening the time lag from the change of the condition of the patient to the start of the examination of the patient by the doctor. The dementia patient observation system described in Japanese Patent Application Laid-Open No. 2008-113720 merely displays the accumulated information.

The present invention is made in view of such circumstances, and a primary object thereof is to provide a dementia care support method, a dementia information output apparatus and a dementia care support system capable of assisting a care concerned person in accurately grasping the symptoms of the patient of dementia and the changes of the symptoms by providing a structure in which a graphical representation representing patient condition information based on the answers to the questions related to the patient of dementia is outputted.

A dementia care support method according to the present invention is a dementia care support method for supporting care and treatment of a patient of dementia in a dementia information output apparatus that outputs patient condition information used for grasping a symptom of the patient and a change of the symptom. A plurality of pieces and/or a plurality of kinds of patient condition information based on an answer to each of a plurality of kinds of questions related to the patient are stored, a graphical representation representing the stored plurality of pieces of patient condition information in predetermined order and/or a graphical representation representing the stored plurality of kinds of patient condition information so as to be associated with each other is generated, and the generated graphical representation is outputted.

A dementia information output apparatus according to the present invention is a dementia information output apparatus that outputs patient condition information used for grasping a symptom of a patient of dementia and a change of the symptom, and is provided with: information storage means for storing a plurality of pieces and/or a plurality of kinds of patient condition information; first generation means for generating a graphical representation representing in predetermined order a plurality of pieces of patient condition information stored in the information storage means; second generation means for generating a graphical representation representing, so as to be associated with each other, a plurality of kinds of patient condition information stored in the information storage means; and graphical representation output means for outputting the graphical representation generated by the first and/or the second generation means.

In the dementia information output apparatus according to the present invention, the information storage means stores a plurality of pieces and/or a plurality of kinds of patient condition information based on an answer to each of a plurality of kinds of questions related to the patient.

The dementia information output apparatus according to the present invention is further provided with: quantification means for quantifying, of the patient condition information stored in the information storage means, non-numerical one of the patient condition information by a predetermined procedure; first difference calculation means for obtaining an absolute value of a difference between two pieces of patient condition information quantified by the quantification means; second difference calculation means for obtaining an absolute value of a difference between, of the patient condition information stored in the information storage means, two pieces of patient condition information expressed as numerical values; threshold value storage means for storing a threshold value that is not less than “0”; and extraction means for extracting, of the patient condition information stored in the information storage means, the patient condition information whose absolute value obtained by the first or the second difference calculation means is not less than the threshold value stored in the threshold value storage means. The first or the second generation means generates a graphical representation representing the patient condition information extracted by the extraction means.

The dementia information output apparatus according to the present invention is further provided with classification means for classifying as a predetermined category the patient condition information stored in the information storage means, and the first generation means generates a graphical representation representing in predetermined order a plurality of kinds of patient condition information classified as the same category by the classification means.

The dementia information output apparatus according to the present invention is further provided with classification means for classifying as a predetermined category the patient condition information stored in the information storage means, and the second generation means generates a graphical representation representing, so as to be associated with each other, each of a plurality of kinds of patient condition information classified as the same category by the classification means and another patient condition information stored in the information storage means.

In the dementia information output apparatus according to the present invention, the patient condition information is based on an answer to a question including a plurality of options, and employs information represented by a selected option.

In the dementia information output apparatus according to the present invention, the patient condition information employs text and/or a numerical value.

A dementia care support system according to the present invention is a dementia care support system for supporting care and treatment of a patient of dementia and provided with: a dementia information output apparatus that outputs patient condition information used for grasping a symptom of the patient and a change of the symptom; and a first and a second communication apparatus capable of communicating with the dementia information output apparatus. The first communication apparatus includes: acceptance means for accepting an answer to each of a plurality of kinds of questions related to the patient; and answer output means for outputting the accepted answer to the dementia information output apparatus, the dementia information output apparatus includes: information storage means for storing a plurality of pieces and/or a plurality of kinds of patient condition information based on the inputted answer; first generation means for generating a graphical representation representing in predetermined order a plurality of pieces of patient condition information stored in the information storage means; second generation means for generating a graphical representation representing, so as to be associated with each other, a plurality of kinds of patient condition information stored in the information storage means; and graphical representation output means for outputting the graphical representation generated by the first and/or the second generation means to the second communication apparatus, and the the second communication apparatus includes display means for displaying the inputted graphical representation or recording means for recording the inputted graphical representation on a recording sheet.

A computer program according to the present invention is a computer program to cause a computer, having information storage means for storing a plurality of pieces and/or a plurality of kinds of patient condition information used for grasping a symptom of a patient of dementia and a change of a symptom, to output the patient condition information, and causes the computer to execute a first generation step of causing the computer to generate a graphical representation representing in predetermined order a plurality of pieces of patient condition information stored in the information storage means; a second generation step of causing the computer to generate a graphical representation representing, so as to be associated with each other, a plurality of kinds of patient condition information stored in the information storage means; and a graphical representation output step of causing the computer to output the graphical representation generated at the first and/or the second generation step.

In the present invention, the dementia information output apparatus is provided with the information storage means, the first and the second generation means and the graphical representation output means. This dementia information output apparatus implements the dementia care support method according to the present invention, and constitutes the dementia care support system according to the present invention. The computer program according to the present invention implements the various means provided in the dementia information output apparatus according to the present invention by means of software by using hardware elements of a computer.

In the information storage means, a plurality of pieces and/or a plurality of kinds of patient condition information are stored. The patient condition information is based on, for example, the answer to each of a plurality of kinds of questions related to the patient of dementia. The patient condition information to be stored in the information storage means is inputted, for example, from the first communication apparatus. In this case, in the first communication apparatus, the answer accepted by the acceptance means is outputted to the dementia information output apparatus by the answer output means. The first generation means generates a graphical representation representing in predetermined order a plurality of pieces of patient condition information stored in the information storage means. The second generation means generates a graphical representation representing, so as to be associated with each other, a plurality of kinds of patient condition information stored in the information storage means.

The graphical representation output means outputs the graphical representation generated by the first and/or the second generation means. When the graphical representation generated by the first and/or the second generation means is outputted to the second communication apparatus by the graphical representation output means, at the second communication apparatus, the inputted graphical representation is displayed by the display means, or the inputted graphical representation is recorded on a recording sheet by the recording means. An advantage is produced that the patient condition information converted into a graphical representation is easy to visually understand compared with simply enumerated pieces of patient condition information.

Moreover, the graphical representation generated by the first generation means is useful for the search of the patient condition information by the care concerned person, the investigation of the transition of the patient condition information or the like. By using the graphical representation generated by the second generation means, for example, the care concerned person can instinctively determine whether there is a correlation between a plurality of kinds of patient condition information or not.

As a result of the above, by viewing the outputted graphical representation, the care concerned person easily understands the patient condition information, and easily and accurately grasps the symptoms of the patient and the changes of the symptoms based on the understood patient condition information.

In the present invention, the dementia information output apparatus is further provided with the quantification means, the first and the second difference calculation means and the extraction means. The quantification means quantifies, of the patient condition information stored in the information storage means, non-numerical one of the patient condition information by a predetermined procedure. Consequently, the patient condition information not expressed as a numerical value can be quantitatively handled. The first difference calculation means obtains the absolute value of the difference between two pieces of patient condition information quantified by the quantification means. The second difference calculation means obtains the absolute value of the difference between, of the patient condition information stored in the information storage means, two pieces of patient condition information expressed as numerical values.

The threshold value storage means stores a threshold value that is not less than “0”. When largely different pieces of patient condition information, a largely changed piece of patient condition information or the like is to be converted into a graphical representation, a high threshold value that is not “0” is stored in the threshold value storage means. On the other hand, when slightly different pieces of patient condition information, a slightly changed piece of patient condition information or the like is to be converted into a graphical representation, a low threshold value that is not “0” is stored in the threshold value storage means. Moreover, when all the pieces of patient condition information are to be converted into a graphical representation, a threshold value “0” is stored in the threshold value storage means. The threshold value stored in the threshold value storage means will hereinafter be referred to as a storage threshold value. Here, a case where the storage threshold value is a high threshold value that is not “0” is shown as an example.

When the absolute value obtained by the first or the second difference calculation means is not less than the storage threshold value, the two pieces of patient condition information are largely different. The patient condition information based on such pieces of patient condition information is highly likely useful when the care concerned person grasps the symptoms of the patient and the changes of the symptoms. On the other hand, when the absolute value obtained by the first or the second difference calculation means is less than the storage threshold value, the two pieces of patient condition information are rarely different or exactly the same. The patient condition information based on such pieces of patient condition information is not likely useful when the care concerned person grasps the symptoms of the patient and the changes of the symptoms. If even the patient condition information based on such pieces of patient condition information is included in the graphical representation, the amount or the variety of information included in the graphical representation is excessive and this may confuse the care concerned person.

Therefore, the extraction means extracts, of the patient condition information stored in the information storage means, the patient condition information whose absolute value obtained by the first or the second difference calculation means is not less than a predetermined threshold value. Then, the first generation means generates a graphical representation representing in predetermined order a plurality of pieces of patient condition information extracted by the extraction means. The second generation means generates a graphical representation, so as to be associated with each other, a plurality of kinds of patient condition information extracted by the extraction means. The graphical representation output means outputs the graphical representation generated by the first and/or the second generation means.

As a result of the above, the graphical representation including the patient condition information extracted by the extraction means, that is, a graphical representation including minimum necessary and sufficient patient condition information can be provided to the care concerned person. In the present invention, the dementia information output apparatus is further provided with the classification means. It is difficult to grasp the symptoms of the patient and the changes of the symptoms from a graphical representation disorderly including patient condition information. Therefore, the classification means classifies as a predetermined category the patient condition information stored in the information storage means. The pieces of patient condition information classified as the same category by the classification means will hereinafter be referred to as similar pieces of patient condition information. It is considered that similar pieces of patient condition information are highly correlated with each other. Therefore, it is desirable that similar pieces of patient condition information be simultaneously referred to when the symptoms of the patient and the changes of the symptoms are grasped. Moreover, it is easy for the care concerned person to compare with each other the similar pieces of patient condition information that are simultaneously referred to.

Therefore, the first generation means generates a graphical representation representing in predetermined order a plurality of kinds of similar pieces of patient condition information. The second generation means generates a graphical representation representing, so as to be associated with each other, a plurality of kinds of similar pieces of patient condition information and another patient condition information. The graphical representation output means outputs the graphical representation generated by the first and/or the second generation means.

As a result of the above, a graphical representation including similar pieces of patient condition information, that is, similar pieces of patient condition information highly correlated with each other can be provided to the care concerned person.

In the present invention, a question related to the patient of dementia includes a plurality of options. Therefore, the selected option is the answer. The patient condition information employs the information represented by the selected option. The answer by selecting from among options makes the answering by the answerer easy compared with the answer by inputting text and/or a numerical value. Therefore, the convenience of the answerer can be improved.

In the present invention, the patient condition information employs text and/or a numerical value. In such a case, to a question related to the patient of dementia, an answer using text and/or a numerical value is made. The answer by inputting text and/or a numerical value improves the degree of freedom of the answer compared with the answer by selecting from among options. Therefore, a wide variety of information related to the patient of dementia can be collected.

According to the dementia care support method, the dementia information output apparatus and the dementia care support system of the present invention, a graphical representation representing a plurality of pieces of patient condition information in predetermined order and/or a graphical representation representing a plurality of kinds of patient condition information so as to be associated with each other can be presented to the care concerned person. By looking at these graphical representations, the care concerned person can easily understand the patient condition information.

The care concerned person can accurately determine the contents and degrees of the symptoms of the patient and the contents and degrees of changes of the symptoms based on the understood patient condition information. That is, according to the present invention, the care concerned person can be assisted in accurately grasping the symptoms of the patient of dementia and the changes of the symptoms and taking an appropriate countermeasure according to the symptoms of the patient and the changes of the symptoms. Further, since it is unnecessary for the care concerned person to manually create a graphical representation, the convenience of the care concerned person can be improved.

The above and further objects and features of the invention will more fully be apparent from the following detailed description with accompanying drawings.

### BRIEF DESCRIPTION OF THE DRAWINGS

FIG. 1 is a block diagram showing the structure of a dementia care support system according to an embodiment of the present invention;

FIG. 2 is a block diagram showing the structure of a server as a dementia information output apparatus according to the embodiment of the present invention;

FIG. 3 is a flowchart showing the procedure of support application use processing executed by a PC (personal computer) provided in the dementia care support system according to the embodiment of the present invention;

FIG. 4 is a flowchart showing the procedure of the support application use processing executed by the PC;

FIG. 5 is a flowchart showing the procedure of communication processing executed between the PC and the server;

FIG. 6 is a schematic view showing an example of an answer input screen displayed on a display unit of the PC;

FIG. 7 is a schematic view showing an example of a case where the answer input screen shown in FIG. 6 is changed according to the number of times of selection of options;

FIG. 8 is a schematic view showing another example of the answer input screen;

FIG. 9 is a schematic view showing an example (monthly changes of the medicine taking condition and the threshold value=0) of a first graphical representation included in a graphical representation output screen displayed on the display unit of the PC;

FIG. 10 is a schematic view showing an example (monthly changes of the medicine taking condition and the threshold value>0) of the first graphical representation included in the graphical representation output screen;

FIG. 11 is a schematic view showing an example (monthly changes of the biological information) of the first graphical representation included in the graphical representation output screen;

FIG. 12 is a schematic view showing an example (monthly table) of the first graphical representation included in the graphical representation output screen;

FIG. 13 is a schematic view showing an example (caregiver Mr. A) of a second graphical representation included in the graphical representation output screen; FIG. 14 is a schematic view showing an example (caregiver Mr. B) of the second graphical representation included in the graphical representation output screen;

FIG. 15 is a schematic view showing an example (whether movement, cognition, etc. are possible or not) of the second graphical representation included in the graphical representation output screen;

FIG. 16 is a schematic view showing an example (the presence or absence of a core symptom) of the second graphical representation included in the graphical representation output screen;

FIG. 17 is a flowchart showing the procedure of graphical representation output processing executed by the server;

FIG. 18 is a flowchart showing the procedure of the graphical representation output processing executed by the server; and

FIG. 19 is a flowchart showing the procedure of the graphical representation output processing executed by the server.

### DETAILED DESCRIPTION OF NON-LIMITING EXAMPLE EMBODIMENTS

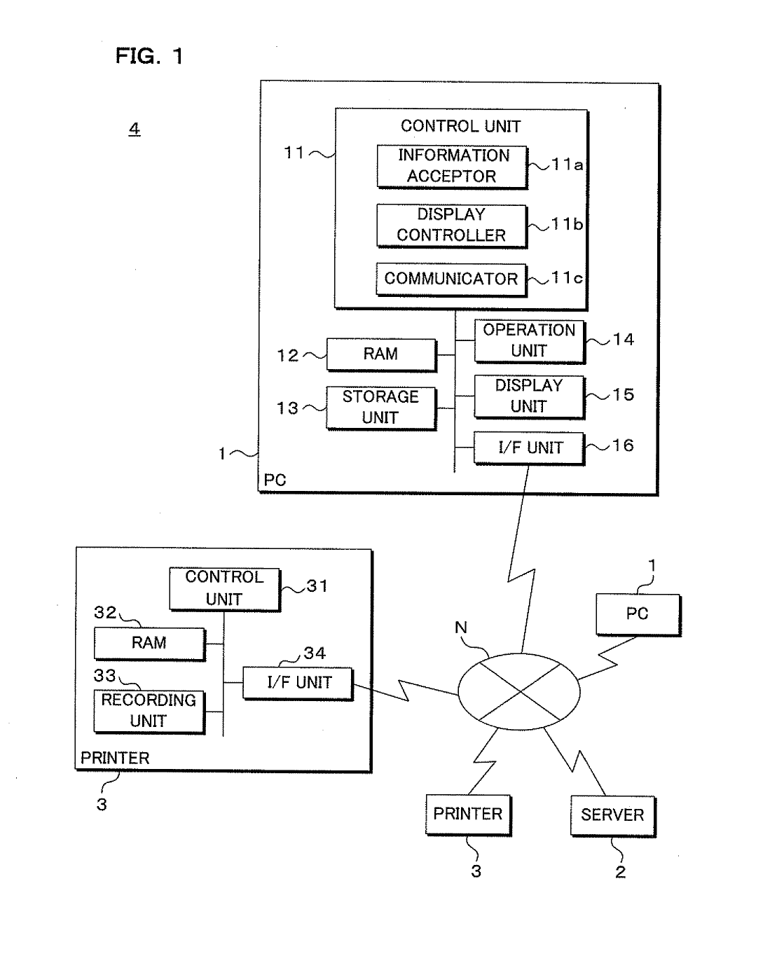

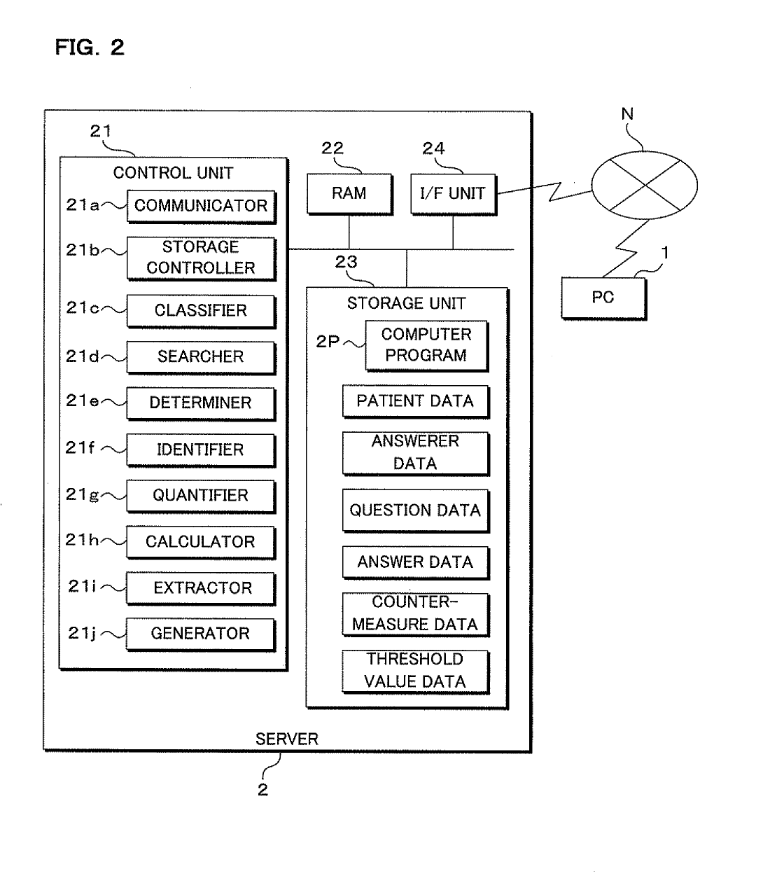

FIG. 1 is a block diagram showing the structure of a dementia care support system 4 according to an embodiment of the present invention. FIG. 1 includes a block diagram showing a PC 1 and a printer 3 provided in the dementia care support system 4. FIG. 1 also includes a functional block diagram of a control unit 11 provided in the PC 1. FIG. 2 is a block diagram showing the structure of a server 2 as the dementia information output apparatus according to the embodiment of the present invention. FIG. 2 includes a functional block diagram of a control unit 21 provided in the server 2.

The dementia care support system 4 shown in FIG. 1 is provided with a plurality of PCs 1, the server 2 and a plurality of printers 3. These are interconnected through a network N. As the network N, the Internet, a LAN or the like is used. These may be connected either by wire or wirelessly. The PCs 1 and the printers 3 are installed in the home of the patient, a care facility, a hospital or the like. The users of these are care concerned persons. The care concerned person is a caregiver (the family of the patient, the care staff of a welfare institution or a facility for insured care, etc.) or a health care professional (a doctor, a clinical psychotherapist, a nurse, etc.). The care concerned person and the patient are different persons.

First, the apparatuses constituting the dementia care support system 4 will be described. The PC 1 is provided with the control unit 11, a RAM (random access memory) 12, a storage unit 13, an operation unit 14, a display unit 15 and an I/F (interface) unit 16. As the control unit 11, a control device such as a CPU (central processing unit) or an MPU (micro processing unit) is used. As the RAM 12, a volatile storage device is used.

As the storage unit 13, a high-capacity nonvolatile storage device is used.

Specifically, as the storage unit 13, a flash ROM (read only memory), an EEPROM (electrically erasable and programmable ROM), a hard disk or the like is used. The storage unit 13 stores a computer program for implementing the dementia care support method by using the dementia care support system 4 (hereinafter, referred to as support application), the image data used during the execution of the support application, and the like.

As the operation unit 14, a keyboard, a mouse and the like are used. The care concerned person operates the operation unit 14 to thereby input necessary information, an instruction and the like to the PC 1. As the display unit 15, for example, a liquid crystal display is used. The I/F unit 16 is for connection between the PC 1 and the network N.

The control unit 11 is the control center of the PC 1. Using the RAM 12 as the work area, the control unit 11 controls the units of the PC 1, and executes various kinds of processings. For example, the control unit 11 functioning as an information acceptor 11 a accepts information, an instruction or the like inputted to the PC 1 through the operation unit 14. The control unit 11 functioning as a display controller 11 b displays on the display unit 15 a screen based on the received image data, the image data stored in the storage unit 13 or the like.

The control unit 11 functioning as a communicator 11c communicates with another apparatus connected to the network N through the I/F unit 16.

The printer 3 is provided with a control unit 31, a RAM 32, a recording unit 33 and an I/F unit 34. As the recording unit 33, a printer engine that records an image on a recording sheet by using toner, ink or the like is used. The control unit 31 is the control center of the printer 3. Using the RAM 32 as the work area, the control unit 31 controls the units of the printer 3, and executes various kinds of processings. For example, the control unit 31 provides the recording unit 33 with the image data received through the I/F unit 34. At this time, the recording unit 33 records an image based on the provided image data on a recording sheet.

As shown in FIG. 2, the server 2 is provided with the control unit 21, a RAM 22, a storage unit 23 and an I/F unit 24. The storage unit 23 has a program storage area storing a computer program 2P functioning as the computer program in the embodiment of the present invention, a storage area (not shown) storing the image data used during the execution of the computer program 2P, and a data storage area storing patient data, answerer data, question data, answer data, countermeasure data and threshold value data each of which will be described later.

The control unit 21 is the control center of the server 2. Using the RAM 22 as the work area, the control unit 21 controls the units of the server 2, and executes various kinds of processings. For example, the control unit 21 loads the computer program 2P stored in the storage unit 23 into the RAM 22, and according to the loaded computer program 2P, implements the dementia care support method according to the embodiment of the present invention.

The computer program 2P of the present embodiment may be recorded on a portable recording medium for distribution, may be distributed through the network N, or may be stored in the storage unit 23 at the time of shipment from the factory. Moreover, the computer program 2P may be read from a recording medium or a distributor without being installed on the server 2 and be directly executed. When the computer program 2P is recorded on a recording medium for distribution, the control unit 21 reads the computer program 2P from the recording medium set in a non-illustrated drive unit incorporated in or externally attached to the server 2, and stores the read computer program 2P in the storage unit 23.

The control unit 21 functioning as a communicator 21 a communicates with another apparatus connected to the network N, through the I/F unit 24. The control unit 21 functioning as a storage controller 21b stores various pieces of information into the RAM 22 or the storage unit 23, and reads the stored information. The control unit 21 functioning as a classifier 21c classifies the information stored in the storage unit 23. The control unit 21 functioning as a searcher 21d searches the various pieces of information stored in the storage unit 23. The control unit 21 functioning as a determiner 21e determines the presence or absence of information, the magnitude correlation and the like. The control unit 21 functioning as an identifier 21f identifies necessary information as a result of the search, the determination or the like. The control unit 21 functioning as a quantifier 21g quantifies non-numeric information. The control unit 21 functioning as a calculator 21h performs various calculations based on the stored information and/or the identified information or the like. The control unit 21 functioning as an extractor 21i extracts the information satisfying a necessary condition in response to the result of the determination by the determiner 21e. The control unit 21 functioning as a generator 21j generates a graphical representation, image data and the like based on the information identified by the identifier 21f and/or the result of the calculation by the calculator 21h and the like.

The PCs 1 and the server 2 are connected through the I/F unit 16, the network N and the I/F unit 24 so that communication can be performed therebetween. The server 2 and the printers 3 are connected through the I/F unit 24, the network N and the I/F unit 34 so that communication can be performed therebetween. In this specification, the data input and output between the PCs 1 and the server 2 and between the server 2 and the printers 3 will be referred to as data transmission and reception.

Now, the dementia care support system 4 will be outlined. In the dementia care support system 4, question content information is transmitted from the server 2 to the PC 1. The question content information represents the contents of a question related to the patient of dementia. On the PC 1, the question represented by the question content information is displayed. The care concerned person inputs an answer to the displayed question to the PC 1. Answer content information representative of the contents of the inputted answer is the text or the numerical value inputted by the answerer, the text or the numerical value of the option selected by the answerer, option identification information assigned to the option selected by the answerer, or the like. The answer content information is transmitted from the PC 1 to the server 2.

In the present embodiment, when the answer content information is the text or the numerical value inputted by the answerer or the text or the numerical value of the option selected by the answerer, patient condition information equals the answer content information. Therefore, in this case, the answer content information transmitted to the server 2 is stored as it is as the patient condition information at the server 2.

On the other hand, when the answer content information is the option identification information assigned to the option selected by the answerer, the patient condition information is the text or the numerical value of the option represented by the answer content information. Therefore, in this case, the answer content information transmitted to the server 2 is converted into the text or the numerical value of the option represented by the answer content information, or is associated with the text or the numerical value of the option represented by the answer content information, whereby the answer content information is stored at the server 2 as the patient condition information. The association between the option identification information and the text or the numerical value of the option is pre-stored (not shown) in the storage unit 23.

As a result of the above, a plurality of pieces of one kind of patient condition information, or one or more pieces of a plurality of kinds of patient condition information are stored at the server 2. The stored patient condition information is converted into a graphical representation at the server 2, and transmitted to the PC 1 or the printer 3. The graphical representation representing the patient condition information is presented to the care concerned person in the form of a display on the PC 1 or recording to a recording sheet by the printer 3. The care concerned person uses the patient condition information in order to grasp the symptoms of the patient and the changes of the symptoms.

The format of the graphical representation is not limited but may be a graph, a diagram, a chart, a table or the like. Hereinafter, the care concerned person who answers questions will also be referred to as an answerer. The answerer in the present embodiment periodically uses the dementia care support system 4 once a month.

Next, the contents of the questions in the present embodiment will be described. The questions related to the patient include ones that should be answered by the answerer and ones that should be answered by the patient.

While the answers by the answerer are inputted to the PC 1 by the answerer himself/herself, the answers by the patient are inputted to the PC 1 by the answerer. Moreover, questions related to the patient include ones for learning the condition of the patient in daily life, ones for learning the condition of the patient in a specific situation, ones for asking the contents of meals, the contents of care, the medicine taking condition and the like, ones for asking the biological information of the patient and ones asking the score of the MMSE (mini mental state examination) which is a kind of dementia examination.

For example, the questions for learning the condition of the patient in daily life ask, specifically, problematic acts such as wandering and filthy acts, everyday acts such as changing clothes and taking a bath, habitually performed acts, and the like. Regarding the problematic acts, to a question “Does the patient do a problematic act A?”, the answerer answers, “The patient does the problematic act A.” or “The patient does not do the problematic act A.”

Regarding the everyday acts, to a question “Can the patient do an everyday act B?”, the answerer answers, “The patient can do the everyday act B.” or “The patient cannot do the everyday act B.” Further, when the patient cannot do the everyday act B, the answerer answers whether partial assistance is necessary or total assistance is necessary.

While the answers to the questions as mentioned above may be made either by selecting from among options or by inputting text, selection from among options is more convenient for the answerer. Regarding the contents of meal, the amount of food intake and the hardness of food are asked. Regarding the amount of food intake and the hardness of food, qualitative answers (for example, whether the amount is larger or smaller than usual, and whether the food is hard or soft) are required.

Quantitative answers may be required regarding the amount of food intake and the hardness of food. Regarding the meals, the menus of the three meals and snacks between meals may be asked. Regarding the contents of care, the presence or absence of a countermeasure being practiced (for example, a conversation on food or tactile care each of which will be described later) and the contents thereof are asked.

The questions to ask the medicine taking condition ask the kind of medicine that the patient takes everyday and the taking amount and taking timing (after meals, between meals, etc.) of the medicine. The answers to the kind of the medicine and the medicine taking timing may be made by selecting from among options or may be made by inputting text. The answer to the medicine taking amount may be made by selecting from among options or may be made by inputting a numerical value. The questions to ask the medicine taking condition may ask the number of times of medicine taking, the medicine taking time, the length of the medicine taking period and the like. The questions to ask the biological information ask the blood pressure, the weight and the body temperature. The question to ask about the biological information may ask the height, the amount of fluid intake, the amount of excretion and the like.

Moreover, the present invention is not limited to the structure in which the answerer manually inputs the answers to the PC 1 but a structure may be adopted in which the measurement results (that is, the answers) are inputted to the PC 1 from a biological information measuring instrument, a recording medium recording the measurement results, or the like. For example, it is preferable that the waveform data of the electrocardiogram which is a piece of biological information be directly transmitted from the electrocardiograph to the PC 1 or the server 2 since it is difficult to manually input it.

Further, the questions to ask information measured every day such as the blood pressure and the body temperature may ask a representative value of the measurement results such as the average value, the highest value or the lowest value, or may ask the measurement results on a specific day (for example, the first day of every month). Further, the following may be performed: Daily measurement results are accepted as the answer, and the control unit 21 obtains the representative value from the daily measurement results as the patient condition information.

Next, the data stored in the data storage area of the storage unit 23 will be described. The data stored in the data storage area of the storage unit 23 includes data previously provided by, for example, a manager of the dementia care support system 4 and data added or modified by the care concerned person during the use of the dementia care support system 4. The data added or modified by the care concerned person is inputted to the PC 1 and transmitted to the server 2.

Next, the patient data and the answerer data will be described. The patient data is formed of the following associated with each other: information to identify the patient (hereinafter, referred to as patient ID); and basic information related to the patient such as the name and sex of the patient. The answerer data is formed of the following associated with one another: information to identify the answerer (hereinafter, referred to as answerer ID); a password; and basic information related to the answerer such as the name and sex of the answerer. When the dementia care support system 4 is used, the input of at least the patient ID, the answerer ID and the password is required. At the server 2, the control unit 21 identifies the patient by using the patient ID, and authenticates the answerer by using the answerer ID and the password. Details of the authentication procedure are omitted.

Next, the question data will be described. The question data is formed of the following associated with one another: presentation order information representative of the order of presentation of the questions; the question content information; symptom identification information described next; and question kind flags and answer acceptance information described later. The symptom identification information is for identifying core symptoms such as amnesia and disorientation and peripheral symptoms such as delusion and wandering. The symptom identification information is included in the question data because the kinds of the core symptoms and the peripheral symptoms are used as indices representative of the degree of progression of dementia. For example, in the early stage of dementia, amnesia appears, in the middle stage, disorientation appears, and in the latter stage, agnosia, apraxia or aphasia appears. Moreover, there are cases where different contents are appropriate for the questions related to patients with different degrees of progression. Further, even between patients in the same latter stage of dementia, there are cases where, for example, questions related to patients with agnosia and questions related to patients with apraxia are different.

Therefore, the question data is structured so that by searching the question content information by using the symptom identification information, the symptom represented by the symptom identification information or the appropriate question content information corresponding to the progression degree of dementia represented by this symptom is obtained (that is, hit) as the search result. When a plurality of pieces of question content information are associated with one piece of symptom identification information, it is desirable that information representative of the priority order be further associated with the question content information. At this time, the hit question content information is used in order of priority.

For the question content information not dependent on the contents of the core symptoms or the peripheral symptoms (for example, a question to ask the height of the patient), setting is made so that such information is hit in the search performed by using any symptom identification information.

Next, the question kind flags of the question data will be described. The question kind flags include: a question kind flag representative of the kind of question contents (for example, whether the question asks the contents of care or the medicine taking condition); a question kind flag representative of whether the question is one that is related to a symptom characteristic of a specific patient or not; and a question kind flag representative of whether the question is one that should be answered only by the patient or only by the care concerned person or whether the question is one that should be answered by both the patient and the care concerned person. The question content information associated with the question kind flag representing that the question is one that is related to a symptom characteristic of a specific patient is further associated with the patient ID of the patient.

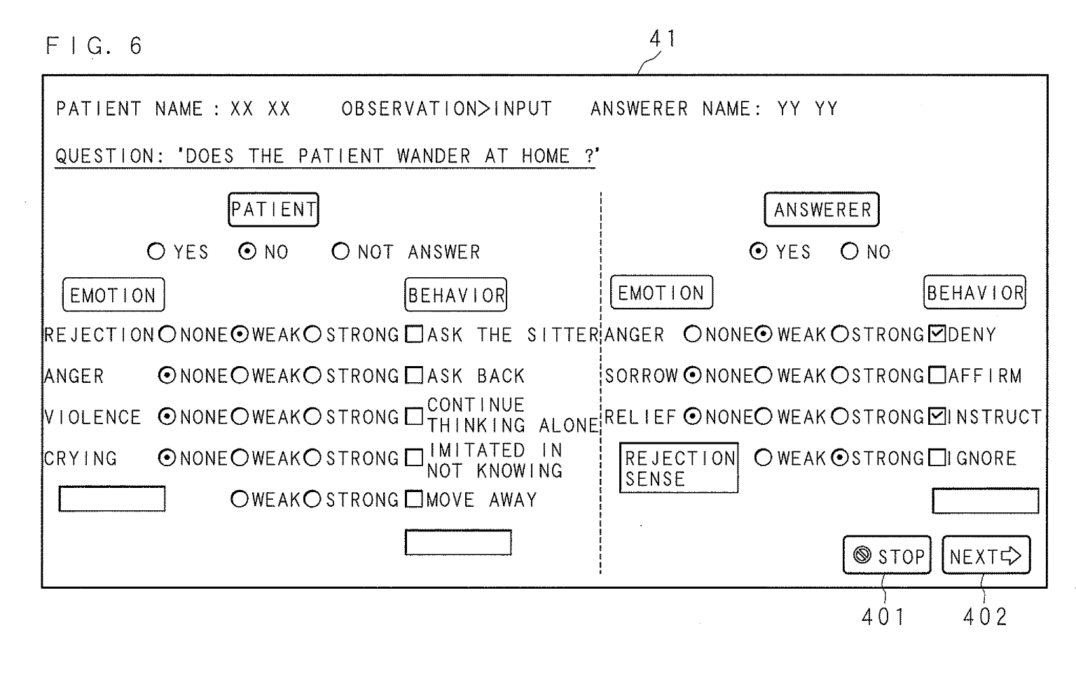

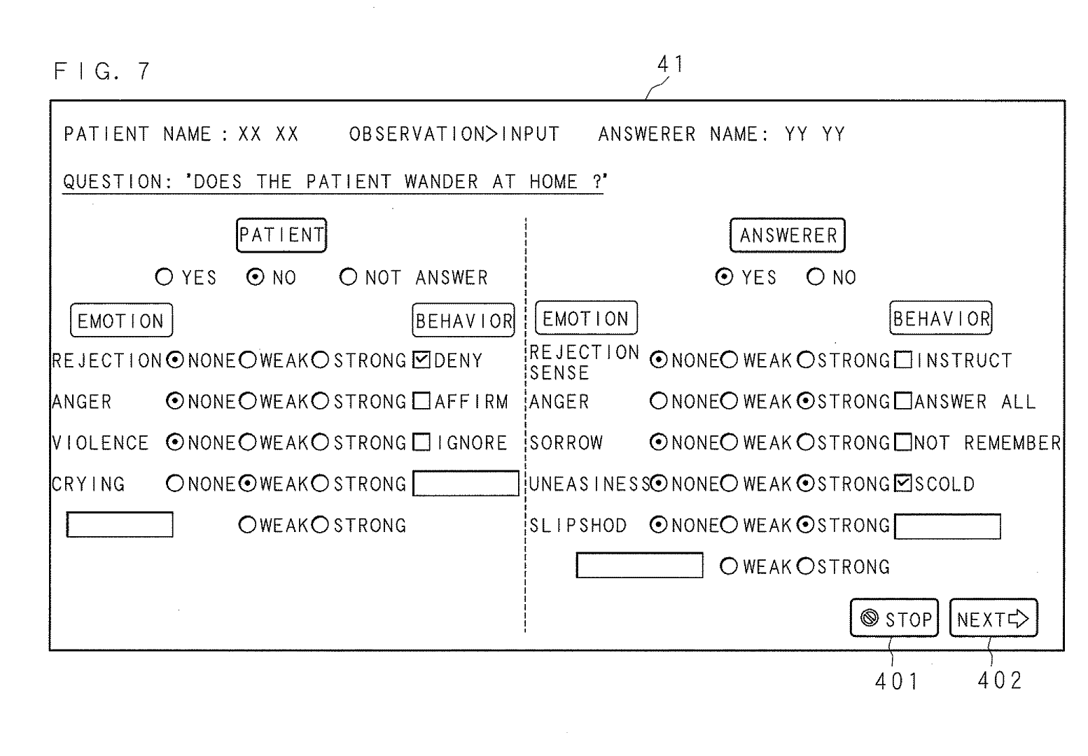

Next, the answer acceptance information of the question data will be described. The answer acceptance information is information necessary for accepting the answers to the questions. For example, in the case of questions to be answered by selecting from among options, the answer acceptance information includes: option content information representative of the contents of the options; the number of times of selection SS of each option in the past; the upper limit number SU and lower limit number SD (SU and SD are natural numbers of 2≦SD<SU) of options to be shown on the answer input screen described later (see FIGS. 6 to 8); a predetermined number of times of selection SF (SF is a natural number); and a flag representative of whether to accept text input of an answer other than the options or not.

On the answer input screen, not less than the number SD and not more than the number SU of options are shown together with the text representative of the contents of the question. In more detail, when there are more than the number SU of options whose number of times of selection SS is not less than the predetermined number of times of selection SF, the selected options are displayed in decreasing order of the number of times of selection SS on the answer input screen. When there are not less than the number SD and not more than the number SU of options whose number of times of selection SS is not less than the predetermined number of times of selection SF, the options whose number of times of selection SS is less than the predetermined number of times of selection SF are not shown on the answer input screen. When there are only less than the number SD of options whose number of times of selection SS is not less than the predetermined number of times of selection SF, at most the number SD of options whose number of times of selection SS is less than the predetermined number of times of selection SF are shown on the answer input screen.

The upper limit number SU, the lower limit number SD and the predetermined number of times of selection SF are pre-stored in the storage unit 23 together with the computer program 2P. However, these may be made arbitrarily changeable by the manager of the dementia care support system 4. While the concrete numerical values of the upper limit number SU and the lower limit number SD are not specifically limited, it is desirable that they be set in a range of 3 to 6. However, when fixed options are always shown on the answer input screen irrespective of the number of times of selection of the options, it is unnecessary that the upper limit number SU, the lower limit number SD and the predetermined number of times of selection SF be included in the answer acceptance information.

The order in which the options are shown on the answer input screen may be the decreasing order of the number of times of selection SS. Moreover, options that are always shown on the answer input screen may be set irrespective of the number of times of selection SS.

The options on the answer input screens 41 and 42 as shown in FIGS. 6 to 8 are associated one-to-one with radio buttons or check buttons, and selection is made by a radio button or a check button being selectively operated. The options the radio buttons or the check buttons of which are not selectively operated (or the selection of which is canceled) are not selected. The selection of the options is not limited to the selection operation by a radio button or a check button but may be made, for example, by a selection operation on a pull-down menu.

The contents of the text inputted to a text box included in the answer input screens 41 and 42 as shown in FIGS. 6 to 8 are transmitted from the PC 1 to the server 2, and added to the question data as a new option. That is, the answerer can add a desired option by inputting text into a text box. The initial value of the number of times of selection SS of the options previously included in the question data is “0”. The initial value of the number of times of selection SS of the option added to the question data is “1”. Thereafter, the number of times of selection SS is counted up by one every time the option is selected.

By associating the number of times of selection SS with the answerer ID of the answerer having selected the option, a structure can be made in which the options shown on the answer input screen are customized for each answerer viewing the answer input screen. Moreover, the initial value of the number of times of selection SS of the added option may be equal to the predetermined number of times of selection SF. In this case, the probability that the added option is shown on the answer input screen is high. This is done because it is considered that the added option is highly likely selected also by an answerer other than the answerer having added the option. Further, by associating the added option with the answerer ID of the answerer who added the option, a structure can be made in which the added option is shown only on the answer input screen viewed by the answerer having added the option.

Next, the answer data will be described. The answer data is formed of the following associated with one another: the patient ID; the patient condition information; the answer date on which the answerer inputted the answer on which the patient condition information is based, to the PC 1; and classification category information described later. For the answer date, when the answerer inputs an answer, the control unit 11 automatically obtains the date counted by a non-illustrated clock unit of the PC 1, and associates the obtained date with the patient condition information as the answer date. The answer date may be manually inputted to the PC 1 by the answerer. The classification category information represents the categories into which the patient condition information is classified. The patient condition information stored in the storage unit 23 is classified into appropriate categories by the control unit 21, and further, associated with the classification category information representative of the classification result.

The categories of the classification are not specifically limited. For example, as the large categories, categories such as daily life, ability and function, cognitive function and problematic act are set. As the small categories of daily life, taking a meal, excreting, taking a bath, sleeping and changing clothes are set. As the small categories of ability and function, movement, cognition, sensation and autonomic nerve are set. As the small categories of the cognitive function, amnesia, disorientation, agnosia, apraxia and aphasia are set. These categories are pre-stored in the storage unit 23. The storage unit 23 functions as the information storage unit in the embodiment of the present invention.

Next, the countermeasure data will be described. The countermeasure data is formed of the following associated with one another: the symptom identification information; countermeasure information described later; and a countermeasure flag representative of whether the countermeasure information is general countermeasure information or countermeasure information to be applied only to a specific patient. With the countermeasure information associated with the countermeasure flag representing that the countermeasure information is to be applied only to a specific patient, the patient ID is further associated. With the symptom identification information, the option content information is separately associated.

Now, the countermeasure information will be described. The countermeasure information includes, for example, countermeasure messages for presenting, to the care concerned person, countermeasures for solving the causes of the core symptoms or the peripheral symptoms. The countermeasure information is edited by doctors.

Next, the reason why the symptom identification information is included in the countermeasure data will be described. The symptom identification information is included in the countermeasure data because there are cases where it is necessary to take different countermeasures according to the core symptoms or the peripheral symptoms that appear on the patient or the degree of progression of dementia. Therefore, the countermeasure data is structured so that by searching the countermeasure information by using the symptom identification information, countermeasure information is hit that is appropriate to the symptom represented by the symptom identification information or the degree of progression of dementia represented by the symptom.

Next, the reason why the option content information is associated with the symptom identification information will be described. For example, a behavior of the patient “even forgetting taking a meal this morning” is highly likely the appearance of a core symptom “amnesia”. For this reason, by associating the option content information “even forgetting taking a meal this morning” with the symptom identification information representative of amnesia, when an option “even forgetting taking a meal this morning” is selected, the countermeasure information can be searched by using the symptom identification information representative of amnesia.

Next, the threshold value data will be described. The threshold value data is formed of the following associated with each other: kind identification information to identify the kind of the patient condition information; and a threshold value. The threshold value is a real value that is not less than “0”. To explain the reason why the threshold value is used, for example, the weight of the patient is shown as an example of the patient condition information and a graphical representation chronologically representing the periodically measured measurement results of the weight is considered as a graphical representation representing a plurality of pieces of patient condition information in predetermined order. When a graph representing the chronological changes of the weight measured once a month (hereinafter, referred to as monthly changes) is generated, the vertical axis of the graph to be generated represents the weight of the patient, and the horizontal axis represents the measurement month.

Although no particular problem occurs when monthly changes for one year are graphed, when changes for two years are graphed, it is necessary to increase the length of the horizontal axis to twice the length for one year or increase the data density of the horizontal axis to twice the density for one year. Further, when the period is prolonged to three years, four years, etc., the amount of information that is included in the graph is extremely large.

While in the months in which the weight of the patient largely increased or decreased, it is considered that there was a change in the physical condition of the patient, in the months in which there was hardly any increase or decrease in the weight of the patient, it is considered that the physical condition of the patient was substantially stable. When the symptoms of the patient, in particular, the changes of the symptoms of the patient are grasped, the weight change when there was a change in the physical condition of the patient is more helpful than the weight change when the physical condition of the patient was substantially stable. Therefore, by extracting the months in which the weight of the patient largely increased or decreased and graphing the changes in the months, the amount of information included in the graphical representation is limited even if the period is three or four years.

For this reason, in the threshold value data, for example, the kind identification information representative of the patient condition information “weight” and a threshold value “2 kg” are associated with each other. The month in which the weight of the patient increased or decreased by two or more kilograms from the weight measured in the previous month and the weight measured in these months are extracted, and a graph is generated in which the extracted ones are shown and the ones not extracted are omitted. On the other hand, when the care concerned person desires a graph also including a month in which the weight slightly increased or decreased from that in the previous month, the kind identification information representative of the patient information “weight” and a threshold value “0.5 kg” are associated with each other in the threshold value data. When the care concerned person desires a graph also including a month in which the weight neither increased nor decreased from that in the previous month, the kind identification information representative of the patient condition information “weight” and a threshold value “0 kg” are associated with each other in the threshold value data.

While in the embodiment as described above, the measurement result in the previous month is subtracted from the measurement result in the present month and it is determined whether the absolute value of the subtraction result is not more than the threshold value included in the threshold value data or not, the present invention is not limited thereto. For example, a structure may be adopted in which the absolute value of the difference between the measurement result in the measurement starting month (or the average value of the measurement results in the past one year) and the measurement result in the present month is obtained and it is determined whether the obtained absolute value is not more than the threshold value or not.

Although a default threshold value is pre-stored in the storage unit 23, a structure may be adopted in which the care concerned person supplies a desired threshold value to the dementia care support system 4 and the supplied threshold value is stored in the storage unit 23 and used more preferentially than the default threshold value. Moreover, a structure may be adopted in which the care concerned person selects a desired threshold value from among a plurality of threshold values pre-stored in the storage unit 23. The storage unit 23 functions as the threshold value storage unit in the embodiment of the present invention. Here, a structure may be adopted in which threshold values related to a plurality of kinds of graphs are associated with one piece of patient condition information so that for the same patient condition information “weight”, a threshold value “2 kg” is used when a monthly change graph is generated and a threshold value “5 kg” is used when a yearly change graph is generated.

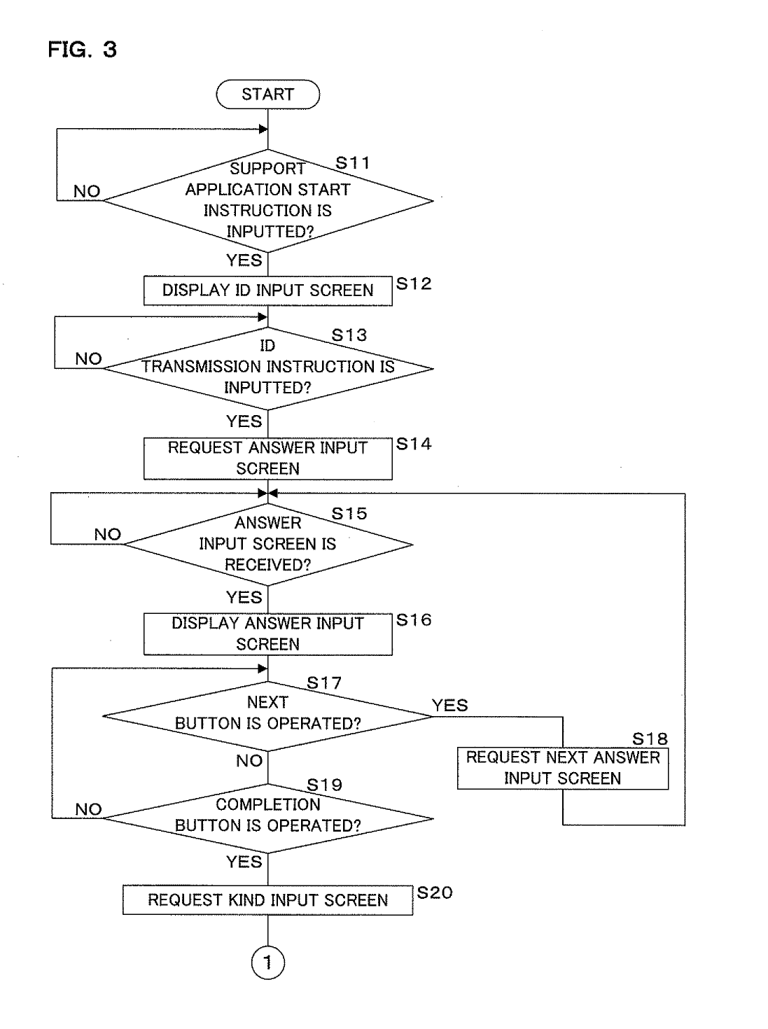

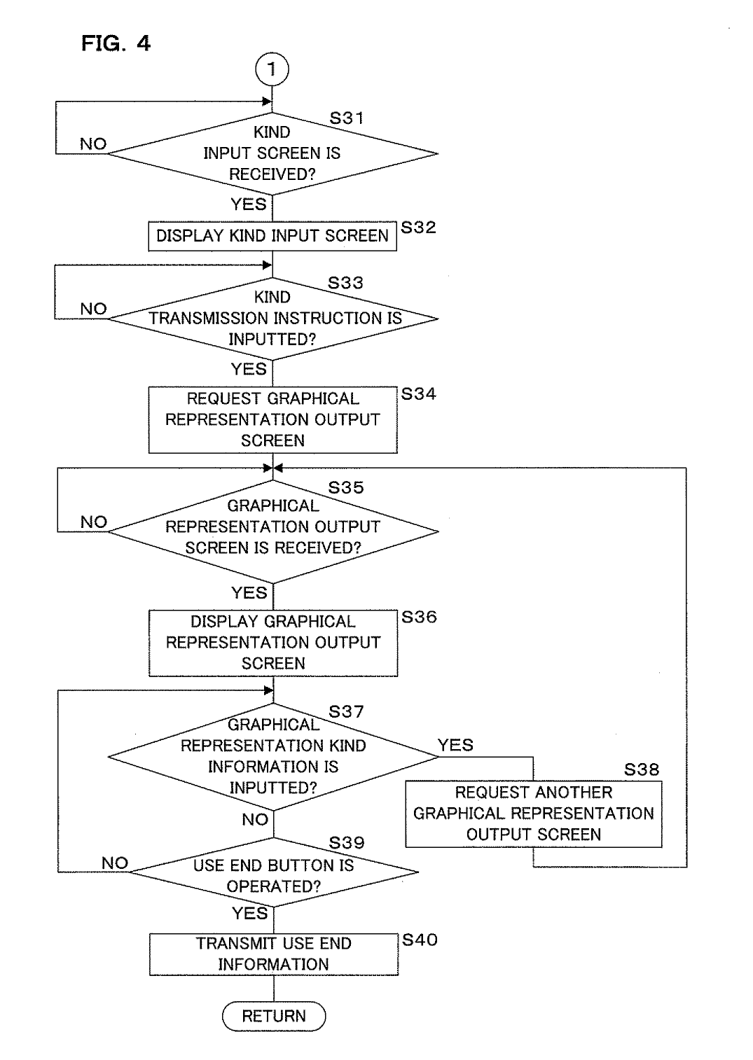

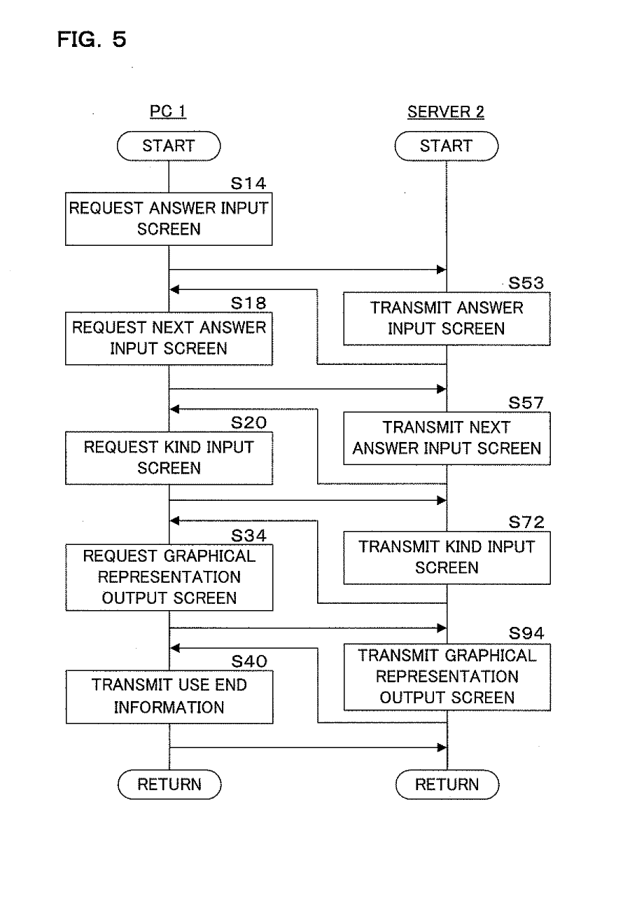

Next, the procedure of use of the dementia care support system 4 by the answerer will be described. FIGS. 3 and 4 are flowcharts showing the procedure of support application use processing executed by the PC 1. FIG. 5 is a flowchart of the procedure of communication processing executed between the PC 1 and the server 2. FIG. 5 is excerpts from FIGS. 3 and 4 and FIGS. 17 to 19, and shows a case where determination is YES only once at S17 and after determination is NO at S37, determination is YES at S39. These steps will be described later. The answerer using the dementia care support system 4 operates, for example, an icon corresponding to the support application to thereby input a support application start instruction to the PC 1.

The control unit 11 determines whether the support application start instruction is inputted or not (S11), and when the instruction is not inputted yet (NO at S11), the control unit 11 executes the processing of S11 again. When the support application start instruction is inputted (YES at S11), the control unit 11 displays a subsequently-described ID input screen (not shown) on the display unit 15 (S12).

The ID input screen is a screen for the answerer to input, to the PC 1, the patient ID, the answerer ID, the password and information specifying the destination of output of the graphical representation (specifically, the PC 1 or the printer 3). A case where the PC 1 is specified as the destination of output of the graphical representation will be mainly described below. The answerer having finished the input of the required information on the ID input screen operates an operation button included in the ID input screen to thereby input an ID transmission instruction to the PC 1.

After the completion of the processing of S12, the control unit 11 determines whether the ID transmission instruction is inputted or not (S13), and when the instruction is not inputted yet (NO at S13), the control unit 11 executes the processing of S13 again. When the ID transmission instruction is inputted (YES at S13), the control unit 11 transmits the patient ID, the answerer ID and the like inputted on the ID input screen to the server 2, and requests the image data of the answer input screen from the server 2 (S14). Hereinafter, the PC 1 having requested the image data of the answer input screen from the server 2 will be referred to merely as PC 1.

As a result of the processing of S14, the image data of the answer input screen is generated and transmitted from the server 2 to the PC 1. The control unit 11 determines whether the image data of the answer input screen is received or not (S15), and when the image data is not received yet (NO at S15), the control unit 11 executes the processing of S15 again. When the image data of the answer input screen is received (YES at S15), the control unit 11 displays the answer input screen on the display unit 15 based on the received image data (S16). At this time, the answer input screen as shown in FIG. 6 described next is displayed on the display unit 15.

FIG. 6 is a schematic view showing an example of the answer input screen displayed on the display unit 15. On the answer input screen 41 shown in FIG. 6, an option and/or text is inputted as an answer. While viewing the answer input screen 41 displayed on the display unit 15 of the PC 1, the answerer inputs to the PC 1 the answer to the question shown on the answer input screen.

The question shown on the answer input screen 41 is a question for learning the condition of the patient in a specific situation. Here, the specific situation is a situation in which the answerer asks the patient the questions related to the patient. An answerer with the answerer name “YY YY” orally asks a patient with the patient name “XX XX” the question shown on the answer input screen 41. At this time, the answerer inputs the answer of the patient to the question on the answer input screen 41. Moreover, the answerer observes the emotions and behaviors of the patient when the patient answers the question, and inputs the result of the observation on the answer input screen 41.

Further, the answerer inputs on the answer input screen 41 the answer of the answerer himself/herself to the question. Moreover, the answerer inputs on the answer input screen 41 his/her own emotions and behaviors when the patient answers the question. The answer input screen 41 includes radio buttons and check buttons for selecting options, text boxes for inputting text, a stop button 401 and a next button 402.

The radio buttons for selecting options correspond to “none”, “weak” and “strong”. When the radio button “weak” or “strong” is selected, the option is regarded as being selected, and when the radio button “none” is selected, the option is regarded as not being selected. The answerer selects the appropriate option, and arbitrarily text-inputs the answer other than the options. To stop answering, the answerer operates the stop button 401.

On the left half of the answer input screen 41, it is inputted that the patient who was asked a question “Does the patient wander at home?” by the answerer answered “No” and represented an emotion of rejecting the answer weakly. Moreover, it is also inputted that the patient when answering the questions did not represent an emotion such as expressing anger, behaving violently or crying and did not exhibit a behavior such as asking the sitter or asking back.

On the right half of the answer input screen 41, it is inputted that the answerer answers “Yes” to the question “Does the patient wander at home?”. This answer is different from that of the patient. From this, it is understood that the patient made an incorrect answer or told a lie in response to the question “Does the patient wander at home?”. Further, on the right half of the answer input screen 41, it is inputted that the answerer represented emotions of weak anger and strong rejection sense when the patient made the answer. Moreover, it is inputted that the answerer performed behaviors of denying the answer of the patient and instructing the patient when the patient made the answer.

If the patient made a correct answer to the question, on the right half of the answer input screen 41, it is inputted that the patient answered “No” to the question “Does the patient wander at home?”. At this time, if the answerer felt a strong sense of relief and trust and affirmed the answer of the patient, “none” is selected for the emotion “anger”, “trust sense” is inputted in the text box of emotion, and “strong” is selected for the emotions “relief” and “trust sense”. Further, neither the behavior “deny” nor “instruct” is selected, and “affirm” is selected.

The options shown on the answer input screen 41 are not always fixed. FIG. 7 is a schematic view showing an example of a case where the answer input screen 41 shown in FIG. 6 is changed according to the number of times of selection of options. Comparing the answer input screen 41 shown in FIG. 6 and the answer input screen 41 shown in FIG. 7, it is apparent that the options for selecting the behaviors of the patient and the emotions and behaviors of the answerer are different although the patient side options for answering whether the patient wandered or not, the answerer side options and the options for selecting the emotions of the patient are the same.

As the patient side options for answering whether the patient wandered or not and the answerer side options, the fixed ones are always shown on the answer input screen irrespective of the number of times of selection of the options. On the other hand, as the options for selecting the emotions and behaviors of the patient and the emotions and behaviors of the answerer, the same or different ones are shown on the answer input screen according to the number of times of selection SS of the options.

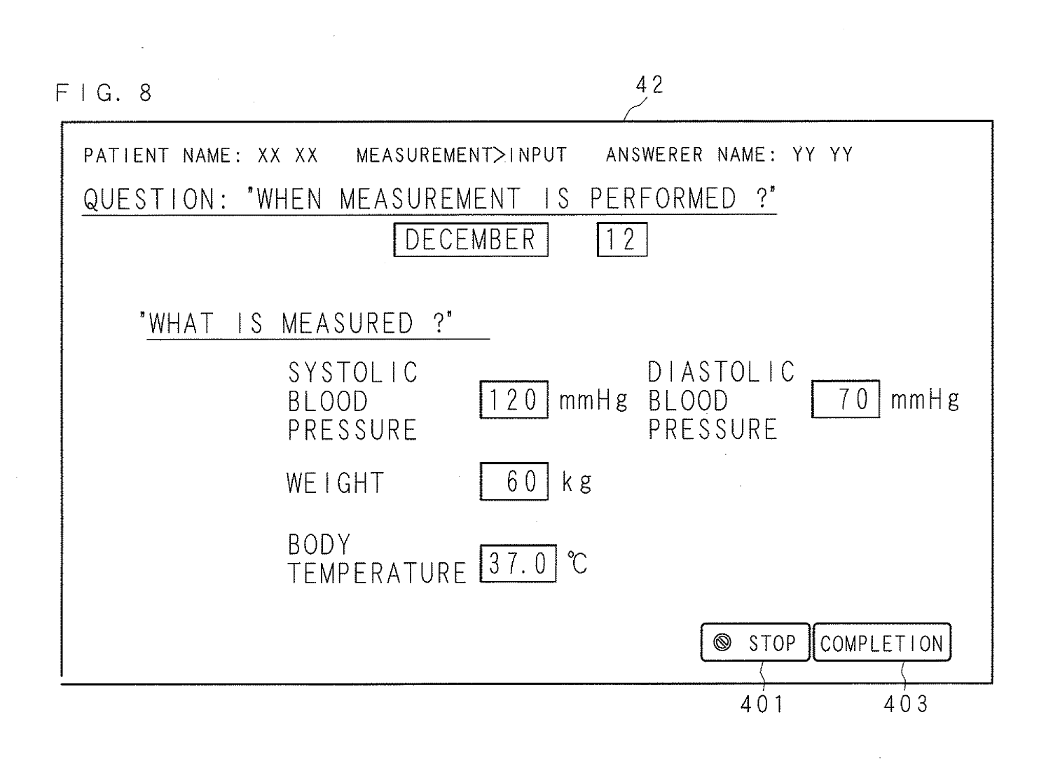

After finishing the input of the answers to the question shown on the answer input screen 41 shown in FIG. 6, the answerer operates the next button 402. Consequently, an answer input screen showing the next question (for example, a later-described answer input screen 42 shown in FIG. 8) is displayed on the display unit 15. For this reason, as shown in FIG. 3, the control unit 11 having finished the processing of S16 determines whether the next button 402 is operated or not (S17), and when the next button 402 is operated (YES at S17), the control unit 11 transmits to the server 2 the answer content information representative of the contents of the answers inputted on the currently displayed answer input screen and the answer date, and requests the image data of the next answer input screen (S18). Then, the control unit 11 shifts the process to S15.

FIG. 8 is a schematic view showing another example of the answer input screen displayed on the display unit 15. On the answer input screen 42 shown in FIG. 8, numerical values are inputted as the answers. The answerer with the answerer name “YY YY” measures the blood pressure, the weight, the body temperature and the like of the patient with the patient name “XX XX” in response to the questions shown on the answer input screen 42, and inputs the measurement date and the measurement results on the answer input screen 42. The answer input screen 42 includes non-illustrated pull-down menus for selecting numerical values, text boxes for inputting numerical values, the stop button 401 and a completion button 403.

The answerer selects the numerical values corresponding to the measurement date from the pull-down menus, and text-inputs the numerical values of the measurement results. To stop answering, the answerer operates the stop button 401. After finishing the input of the answers to the questions shown on the answer input screen 42, the answerer operates the completion button 403. Consequently, a later-described kind input screen (not shown) is displayed on the display unit 15. For this reason, as shown in FIG. 3, when the next button 402 is not operated (NO at S17), the control unit 11 determines whether the completion button 403 is operated or not (S19).

When the completion button 403 is operated (YES at S19), the control unit 11 transmits to the server 2 the answer content information representative of the contents of the answers inputted on the currently-displayed answer input screen and the answer date, and requests the image data of the kind input screen from the server 2 (S20). On the other hand, when the completion button 403 is not operated (NO at S19), the control unit 11 returns the process to S17. After the completion of the processing of S20, as shown in FIG. 4, the control unit 11 determines whether the image data of the kind input screen is received or not (S31), and when the image data is not received yet (NO at S31), the control unit 11 executes the processing of S31 again. When the image data of the kind input screen is received (YES at S31), the control unit 11 displays the kind input screen on the display unit 15 based on the received image data (S32).

Now, the kind input screen will be described. The kind input screen is a screen for the answerer to input subsequently-described graphical representation kind information to the PC 1. The graphical representation kind information represents the kind of graphical representation that the answerer desires to view. This employs the title of the graphical representation (for example, “Daily Changes of the Weight of the Patient”), parameters to be represented by the vertical axis and the horizontal axis (for example, “the vertical axis represents the weight of the patient and the horizontal axis represents the measurement month”) or the like. Further, the graphical representation kind information may include the format of the graphical representation (for example, “line graph” or “bar graph”) or the range of the parameter represented by the horizontal axis (for example, half a year from January of this year). A structure may be adopted in which a threshold value or the destination of output of the graphical representation is accepted on the kind input screen in addition to the graphical representation kind information.

The answerer having finished the input of the graphical representation kind information on the kind input screen operates the operation button included in the kind input screen to thereby input a kind transmission instruction to the PC 1. After the completion of the processing of S32 shown in FIG. 4, the control unit 11 determines whether the kind transmission instruction is inputted or not (S33), and when the instruction is not inputted yet (NO at S33), the control unit 11 executes the processing of S33 again. When the kind transmission instruction is inputted (YES at S33), the control unit 11 transmits to the server 2 the graphical representation kind information inputted on the kind input screen, and requests the image data of a later-described graphical representation output screen from the server 2 (S34).

As a result of the processing of S34, the image data of the graphical representation output screen is generated and transmitted from the server 2 to the PC 1. Then, the control unit 11 determines whether the image data of the graphical representation output screen is received or not (S35), and when the image data is not received yet (NO at S35), the control unit 11 executes the processing of S35 again. When the image data of the graphical representation is received (YES at S35), the control unit 11 displays the graphical representation output screen on the display unit 15 based on the received image data (S36).

The graphical representation output screen displayed on the display unit 15 as a result of the processing of S36 includes a graphical representation representing the patient condition information, an information acceptor (not shown) for accepting the graphical representation kind information and a use end button (not shown). Moreover, the countermeasure information is sometimes included in the graphical representation output screen. The answerer having finished the viewing of the graphical representation output screen operates the use end button on the graphical representation output screen to end the use of the dementia care support system 4. When desiring to view another graphical representation, the answerer inputs the graphical representation kind information at the information acceptor of the graphical representation output screen.

After the completion of the processing of S36, the control unit 11 determines whether the graphical representation kind information is inputted at the information acceptor or not (S37), and when the information is inputted (YES at S37), the control unit 11 transmits to the server 2 the graphical representation kind information inputted at the information acceptor and requests the image data of another graphical representation output screen from the server 2 (S38). After the completion of the processing of S38, the control unit 11 shifts the process to S35. When the graphical representation kind information is not inputted at the information acceptor (NO at S37), the control unit 11 determines whether the use end button is operated or not (S39), and when the use end button is not operated (NO at S39), the control unit 11 returns the process to S37. When the use end button is operated (YES at S39), the control unit 11 transmits use end information to the server 2 (S40), and after temporarily finishing the support application use processing, the control unit 11 returns the process to

S11.

The information acceptor of the graphical representation output screen may have a structure of accepting a threshold value or the destination of output of the graphical representation in addition to the graphical representation kind information. When the stop button 401 is operated, an answer stop instruction is inputted to the PC 1. When the answer stop instruction is inputted, the control unit 11 interrupts the processing under execution, and after forcibly terminating the support application use processing, the control unit 11 returns the process to S11.

The answerer views the graphical representation output screen displayed on the display unit 15 to thereby grasp the patient condition information (and the countermeasure information) included in the graphical representation output screen. Then, the answerer determines the contents and degrees of the symptoms of the patient and the contents and degrees of the changes of the symptoms based on the grasped patient condition information. Further, the answerer takes appropriate countermeasures according to the symptoms of the patient and the changes of the symptoms based on the result of the determination and with reference to the grasped countermeasure information.

By the support application use processing shown in FIG. 3 being executed, the PC 1 functions as the first and second communication apparatuses in the embodiment of the present invention. From the execution of the processing of S16 to when the determination at S17 becomes YES, the control unit 11 functions as the acceptor in the embodiment of the present invention. The control unit 11 executing the processing of S18 or S20 functions as the answer output unit in the embodiment of the present invention. Moreover, by the control unit 11 executing the processing of S36, the display unit 15 functions as the display unit in the embodiment of the present invention.

Here, the PC 1 functioning as the first communication apparatus and the PC 1 functioning as the second communication apparatuses may be separate. In this case, the PC 1 displaying the answer input screen and the PC 1 displaying the graphical representation output screen are different.

The answerer, and the care concerned person viewing the graphical representation output screen may be the same person or may be different persons. Moreover, the first or the second communication apparatus may be structured by using a PDA (personal digital assistance), a smartphone, a mobile telephone or the like instead of the PC 1. Further, the operation unit 14 and the display unit 15 may be structured by using a touch panel. It is desirable that this touch panel have a size of 3 to 15 inches, particularly, when the first or the second communication apparatus is portable. This is because a touch panel of this size makes it easy for the care concerned person to view the answer input screen, the graphical representation output screen and the like and to input necessary information, instructions or the like, and further, is suitable for being carried.

Furthermore, the first communication apparatus may be structured by using an optical mark reader instead of the PC 1. In this case, the answerer answers the questions by filling in marks on a mark sheet. The optical mark reader reads the filled marks on the mark sheet, and transmits to the server 2 the read contents, that is, the answer content information representative of the selected options. Moreover, the first communication apparatus may be structured by using a scanner, a digital multifunction apparatus or the like instead of the PC 1. In this case, the answerer manually writes characters, symbols or the like on an answer sheet to thereby answer the questions. The scanner, the digital multifunction apparatus or the like reads the manually written answers as images, and further, character-recognizes them, thereby transmitting the answer content information representative of the contents of the answers to the server 2.

Next, a case where the printer 3 is specified as the destination of output of the graphical representation will be described. In this case, as a result of the processing of S34, the image data of the graphical representation output screen is transmitted from the server 2 to the printer 3. At this time, at the printer 3, an image corresponding to the graphical representation output screen is recorded on a recording sheet based on the received image data. The printer 3 functions as the second communication apparatus in the embodiment of the present invention. The recording unit 33 functions as the recording unit in the embodiment of the present invention. The second communication apparatus may be structured by using a facsimile, a digital multifunction apparatus or the like instead of the printer 3. Moreover, a structure may be adopted in which the printer 3 is not connected to the network N but connected directly to the PC 1 and the image data transmission to the printer 3 is performed through the PC 1.

While in the present embodiment, the structure in which the graphical representation output screen is displayed through the stage where the answerer inputs the answers is shown as an example, the present invention is not limited thereto. A structure may be adopted in which the graphical representation output screen is displayed while a stage where the care concerned person inputs the answers is omitted. In the former case, the latest patient condition information can be shown in the graphical representation (for example, the patient condition information of this month) included in the displayed graphical representation output screen. On the other hand, in the latter case, past patient condition information (for example, the patient condition information of up to the last month) is shown in the graphical representation included in the displayed graphical representation output screen.

There is a possibility that the answerer desires to supply given information to the dementia care support system 4. For example, even if there is an answerer who thinks that information on the favorite color of the patient is useful for the diagnosis of dementia, it is impossible for the answerer to input this information to the PC 1 unless a question to ask the favorite color of the patient is shown on the answer input screen. In other words, such a case is a case where a question desired by the answerer is absent.

Therefore, the dementia care support system 4 may have a structure in which after the input of the answers to the questions shown on the answer input screen is all finished, a question input screen is displayed on the display unit 15. The answerer inputs at least the question content information on the question input screen, and in some cases, also inputs the symptom identification information, the question kind flag and/or the answer acceptance information or the like. The information inputted on the question input screen is transmitted to the server 2 and added to the question data stored in the storage unit 23. As a result, the new question inputted by the answerer is shown on the answer input screen when another answerer uses the dementia care support system 4 or when the answerer having inputted the new question uses the dementia care support system 4 again.

As described above, with the structure in which the questions created by the answerer are reflected in the dementia care support system 4, since the information for judgment to grasp the symptoms of the patient and the changes of the symptoms can be enriched, the symptoms of the patient and the changes of the symptoms can be grasped from more various perspectives.

Next, the graphical representations included in the graphical representation output screen will be described. The graphical representation output screen includes a graphical representation representing a plurality of pieces of patient condition information in predetermined order and/or a graphical representation representing a plurality of kinds of patient condition information so as to be associated with each other. The former is a graphical representation generated by the first generator in the embodiment of the present invention, and the latter is a graphical representation generated by the second generator in the embodiment of the present invention. Hereinafter, the former will be referred to as the first graphical representation, and the latter, as the second graphical representation.

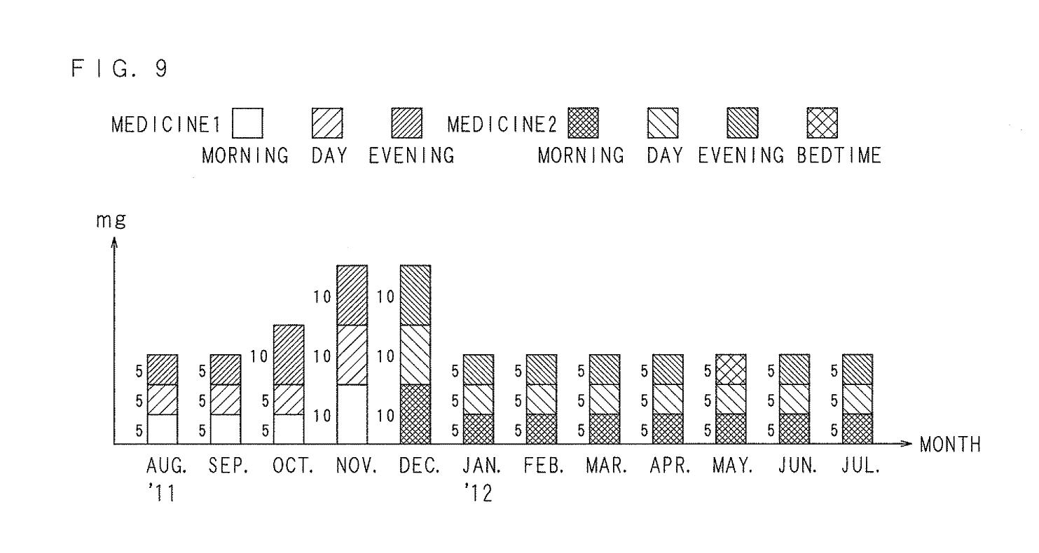

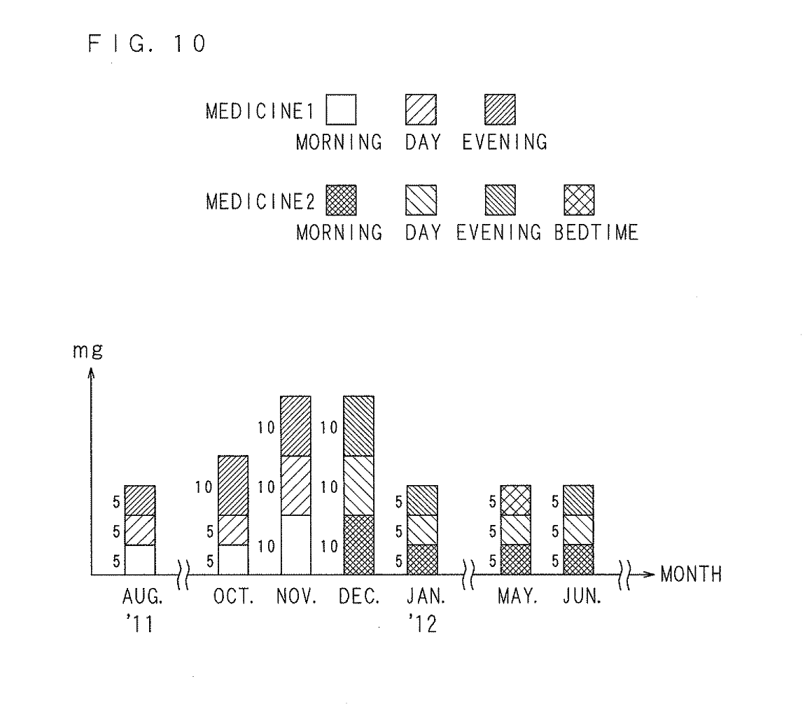

First, the first graphical representation will be described. The first graphical representation is, for example, a line graph with the horizontal axis representing the time and the vertical axis representing the quantity, a histogram with the horizontal axis representing the class and the vertical axis representing the frequency, or a table where the item names are arranged in order of alphabet, a bar graph or the like. FIGS. 9 to 12 are schematic views each showing an example of the first graphical representation included in the graphical representation output screen. These are examples of the first graphical representation included in the graphical representation output screen displayed on the display unit 15 when the answerer uses the dementia care support system 4 in July, 2012.

The graph shown in FIG. 9 is a cumulative bar graph showing monthly changes of the medicine taking condition. The horizontal axis represents the twelve months from August, 2011 to July, 2012, and the vertical axis represents the medicine taking amount [mg]. The parts of the cumulative bar graph are color-coded according to the kind of medicine and the medicine taking timing, and the longitudinal lengths of the parts are proportional to the medicine taking amount. Moreover, the numbers shown on the left side of the bars represent the medicine taking amounts. The graph shown in FIG. 9 shows the medicine taking condition over the twelve months in detail. This is because the threshold value used when the graph shown in FIG. 9 is generated is “0”.

Looking at the graph shown in FIG. 9, the following is apparent: In August and September, the patient took a total of 15 mg of medicine 1, 5 mg at each of after breakfast (“morning” in the figure), after lunch (“day” in the figure) and after dinner (“evening” in the figure); however, in October, the taking amount of the medicine 1 after dinner increased to 10 mg, and in November, the patient took a total of 30 mg of medicine 1 with the medicine taking amount at each of after breakfast and after lunch being 10 mg. From this, it can be speculated that although a symptom change of the patient that leads to an increase or a decrease of the medicine taking amount did not occur in August or September, a symptom change of the patient that leads to an increase of the medicine taking amount occurred in October and November.

Moreover, the medicine taken by the patient has been changed from the medicine 1 to a medicine 2 since December. Moreover, the medicine 2 taken after dinner until April and from June is taken before going to bed (“bedtime” in the figure) in May. From this, it can be speculated that a symptom change leading to a medicine kind change occurred in December and a symptom change leading to a medicine taking timing change occurred in May. However, the medicine taking amount in November and December is a fixed amount of 30 mg, and the medicine taking amount in January and succeeding months are a fixed amount of 15 mg. For this reason, there is a possibility that a medicine kind or a medicine taking timing change is overlooked by the care concerned person.

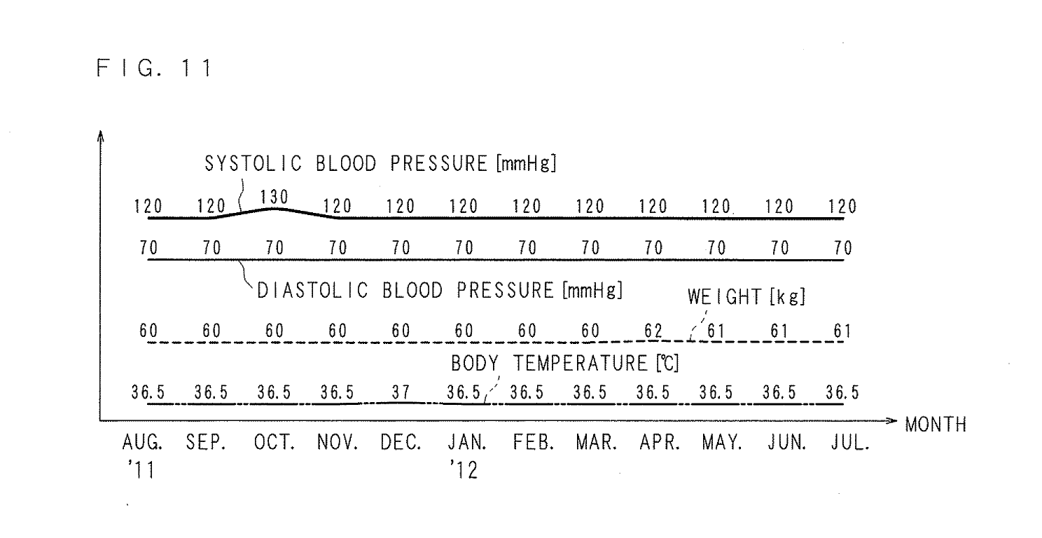

Therefore, there area cases where it is preferable to present the graph shown in FIG. 10 to the care concerned person instead of the graph shown in FIG. 9. The graph shown in FIG. 10 is a cumulative bar graph showing the monthly changes of the medicine taking condition like that of FIG. 9. However, the graph shown in FIG. 10 shows the medicine taking conditions in seven months excerpted from those in twelve months. For this reason, when the graph shown in FIG. 10 is generated, a threshold value higher than “0” is used.

When the threshold value related to the total medicine taking amount is “1”, the absolute value of the result of subtraction of the total medicine taking amount in September from the total medicine taking amount in August is “0”, which is lower than the threshold value. Therefore, the data in September is omitted from the graph shown in FIG. 10, and an omission mark is shown in this part. On the other hand, the absolute value of the result of subtraction of the total medicine taking amount in October from the total medicine taking amount in September is “5”, which is not less than the threshold value. Therefore, in the graph shown in FIG. 10, the data in October is shown. Likewise, in the graph shown in FIG. 10, data in November and January is shown.

As described above, the structure in which the threshold value related to the total medicine taking amount is “1” is a structure in which even an increase or a decrease of as small as 1 mg of the total medicine taking amount is regarded as a medicine taking condition change and extraction is performed. When a structure is adopted in which unless the total medicine taking amount increases or decreases in a large amount (for example, not less than 10 mg), the change is not regarded as a medicine taking condition change and extraction is not performed, the threshold value related to the medicine taking amount is set to “10”. In this case, from the graph shown in FIG. 10, the data in October is omitted.

Since the medicine kind and the medicine taking timing are not expressed as numerical values (that is, they are non-numerical values), the absolute value of the subtraction result cannot be obtained if they remain so. For the medicine kind and the medicine taking timing, after they are quantified by a predetermined procedure, the absolute value of the subtraction result is obtained. Specifically, each kind of medicine is assigned with an appropriate numerical value for identification. For example, the threshold value related to the kind of medicine is “1”, and the medicine 1 is assigned with “1” and the medicine 2, with “2”. As in August and September, when the same kind of medicine is taken, the absolute value of the result of subtraction of the medicine 1 from the quantified medicine 1 is “0”, which is lower than the threshold value.

Therefore, the data in September is omitted from the graph shown in FIG. 10. On the other hand, as in November and December, when different kinds of medicines are used, the absolute value of the result of subtraction of the medicine 2 from the quantified medicine 1 is “1”, which is not less than the threshold value. Therefore, in the graph shown in FIG. 10, the data in December is shown.

Moreover, regarding the medicine taking timing, for example, when after dinner is assigned with “1800”, before going to bed is assigned with “2100” and the threshold value is “100”, in the graph shown in FIG. 10, the data in May and June is shown. By looking at the graph shown in FIG. 10, the months in which the medicine taking condition was changed (that is, the months to which the care concerned person should pay attention) are easily found. Thus, the care concerned person can easily notice not only an increase or a decrease of the medicine taking amount but also changes of the kind of medicine and the medicine taking timing.

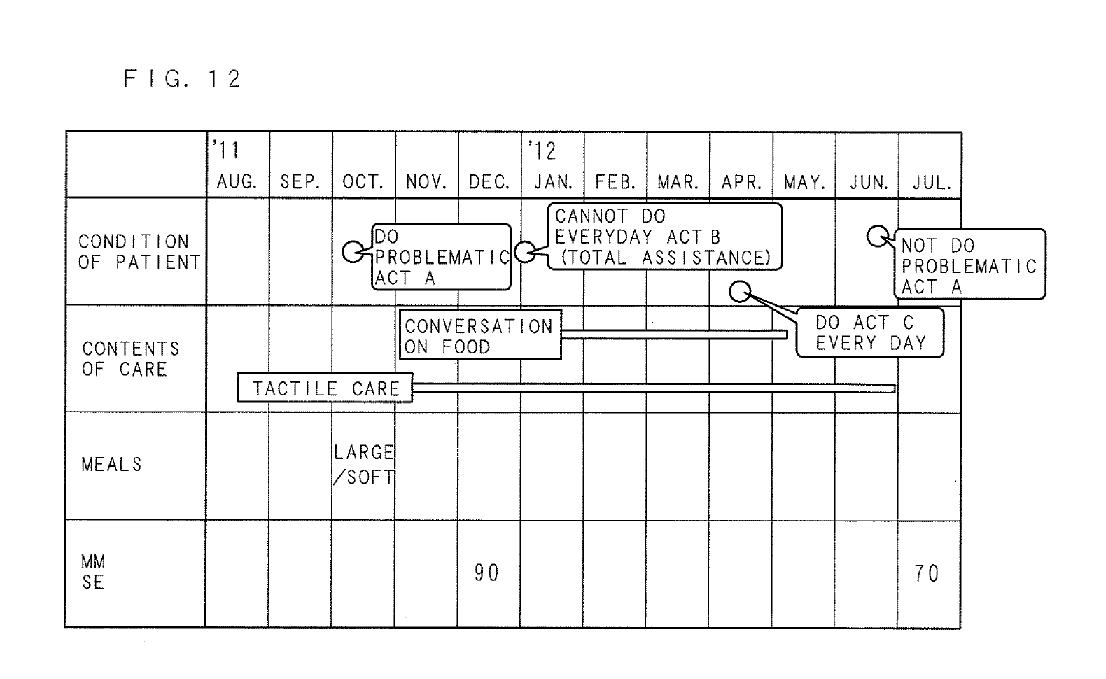

The graphical representation shown in FIG. 11 is a line graph showing the monthly changes of the biological information. This graph shows in detail four kinds of biological information over twelve month. Specifically, the thick solid line represents the systolic blood pressure, the thin solid line represents the diastolic blood pressure, the broken line represents the weight, and the chain double-dashed line represents the body temperature. The horizontal axis represents the twelve months from August, 2011 to July, 2012, and the vertical axis represents the systolic blood pressure and the diastolic blood pressure [mmHg], the weight [kg] and the body temperature [degrees C]. The numbers shown in the line graph represent the measurement values of the pieces of biological information.

If the line graphs of the systolic blood pressure, the diastolic blood pressure, the weight and the body temperature are separately generated, the care concerned person who wants to check the monthly changes of the four kinds of biological information necessarily refers to four line graphs separately, which is inconvenient. Therefore, the line graphs of the systolic blood pressure, the diastolic blood pressure, the weight and the body temperature are shown in the same graph. However, if a line graph of the medicine taking amount is also shown in this graph, the convenience of the care concerned person who wants to check the monthly changes of the biological information is hampered.

Therefore, the pieces of patient condition information are classified into predetermined categories. For example, the systolic blood pressure, the diastolic blood pressure, the weight and the body temperature are classified as a category “biological information”, and the medicine taking amount is classified as a category “medicine taking condition”. At this time, the systolic blood pressure, the diastolic blood pressure, the weight and the body temperature are associated with classification category information representative of the category “biological information”, and the medicine taking amount is associated with classification category information representative of the category “medicine taking condition”. The pieces of patient condition information classified as the same category, that is, the pieces of patient condition information associated with the same classification category information are collectively shown in one graphical representation. That is, the graph shown in FIG. 11 represents the four kinds of patient condition information classified as the same category “biological information” in predetermined order (specifically, in chronological order). One piece of patient condition information may be classified as a plurality of categories.

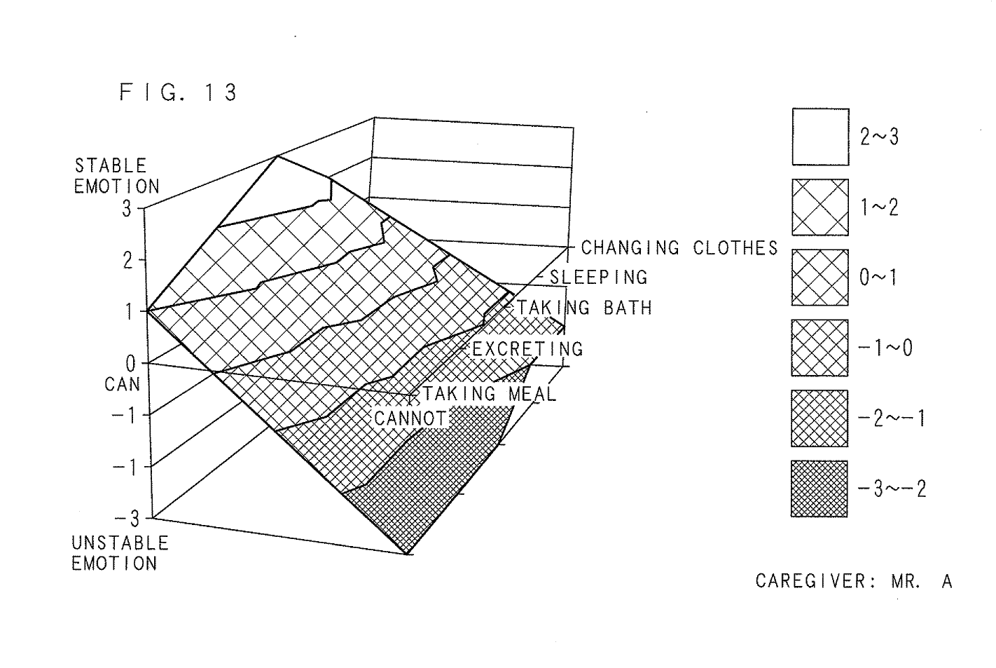

FIG. 12 is a table representing a yearly table of the patient condition information. The first to twelfth columns of the table shown in FIG. 12 show the twelve months from August, 2011 to July, 2012. The first row shows the condition of the patient in daily life, the second row shows the contents of care, the third row shows the contents of meals, and the fourth row shows the score of the MMSE. The four kinds of patient condition information, the condition of the patient in daily life, the contents of care, the contents of meals and the score of the MMSE are patient condition information classified as a category “patient condition information to be shown in the yearly table”.

When patient condition information other than the four kinds of patient condition information shown herein as an example is also classified as the “patient condition information to be shown in the yearly table”, the table shown in

FIG. 12 is obtained by performing the processing of previously selecting four kinds from among five or more kinds of patient condition information classified as the “patient condition information to be shown in the yearly table” before generating the graphical representation.

First, the first row of the table shown in FIG. 12 will be described. To a question to ask the condition of the patient in daily life, the answerer answered that “the patient did the problematic act A” in October, and answered that “the patient did not do the problematic act A” in June. Moreover, the answerer answered that “the patient could not do the everyday act B” and “total assistance was necessary” in January, and answered that “the patient did an act C every day” in April. Thus, in the first row of the table shown in FIG. 12, the contents of the answers of the answerer are shown in the columns of October, January, April and June.

Looking at this row, the care concerned person finds that the patient had been doing the problematic act A since October and has not done the problematic act A since June. Moreover, the care concerned person finds that total assistance has been necessary for the everyday act B of the patient since January. Further, the care concerned person finds that the patient has habitually been doing the act C since April.

Next, the second row of the table shown in FIG. 12 will be described. To a question to ask about the contents of care, the answerer answered that conversation on food was performed every month from January to May. Moreover, the answerer answered that tactile care was performed from November to June. Therefore, in the second row of the table shown in FIG. 12, a lateral bar representing that conversation on food is performed is shown from January to May, and a lateral bar representing that tactile care is performed is shown from November to June.

Next, the third row of the table shown in FIG. 12 will be described. To a question to ask the amount of meals, the answerer answered that the amount of meals was large only in October, and answered that the amount of meals was normal in the other months. To a question to ask the hardness of food, the answerer answered that the food was soft only in October, and answered that the hardness of food was normal in the other months. Therefore, in the third row of the table shown in FIG. 12, a word “large” representing that the meal amount is large and a word “soft” representing that the food is soft are shown in the column of October. That the meal amount is normal and that the hardness of food is normal are omitted since they are not noteworthy information.

Next, the fourth row of the table shown in FIG. 12 will be described. The patient took the MMSE in December and July. The scores which were the results of the MMSE were 90 and 70. Consequently, to a question to ask the score of the MMSE, the answerer answered that they were 90 and 70 in

December and July, respectively. Therefore, in the fourth row of the table shown in FIG. 12, the scores 90 and 70 are shown in the column of December and in the column of July.

Next, the conversation on food will be described. The conversation on food is a countermeasure for a case where the patient does problematic acts about meals (for example, throwing food, eating too much, dropping much food, not wanting to take meals, or demanding a meal again and again). For example, there is a possibility that a patient who throws food does such a problematic act because the patient does not recognize that it is food (agnosia) or does not know how to eat it (apraxia). Therefore, it is considered effective that the care concerned person explains the food, shows how to eat it and eats it together with the patient with a smile saying that it is delicious.

Moreover, there is a possibility that the patient who demands a meal again and again does such a problematic act because the patient cannot obtain the satisfaction of having taken meals since the patient does not recognize the food that he/she ate or cannot remember having taken a meal (agnosia). Therefore, in such a case, it is also considered effective that, while the patient is taking a meal, the care concerned person explains the food and eats it together with the patient with a smile saying that it is delicious and after the meal, talks to the patient to make a conversation such that *** (the name of the food) we ate a little while ago was very delicious. Therefore, by looking at the table shown in FIG. 12, it can be speculated that the patient has a core symptom such as agnosia or apraxia in the period where conversation on food is performed.

Next, tactile care will be described. Tactile care is a kind of massage (touch care) of gently touching or stroking the body of the patient. Tactile care has the effect of reducing physical fatigue and psychological stress and bringing a sense of ease to the patient. Therefore, by looking at the table shown in FIG. 12, it can be speculated that the patient has a peripheral symptom of uneasiness in the period where tactile care is performed.

Moreover, looking at the first and second rows of the table shown in FIG. 12, tactile care was started in the month following the month in which the patient started doing the problematic act A and tactile care was ended in the month following the month in which the patient stopped doing the problematic act A.

From this, it can be speculated that there is a strong connection between the problematic act A of the patient and the uneasiness of the patient and the problematic act A is stopped by reducing the uneasiness of the patient by tactile care.

Here, it is assumed that in the countermeasure data, the symptom identification information indicative of uneasiness and the countermeasure information indicative of tactile care are associated with each other and further, the symptom identification information indicative of uneasiness and the option content information indicating that the patient starts to perform the problematic act A are associated with each other. In this case, in October when an option that the patient started to perform the problematic act A was selected, the control unit 21 can generate a yearly table of the twelve months from November, 2010 to October, 2011 and a graphical representation output screen showing a countermeasure message recommending the start of tactile care.

The above-described graphical representations shown in FIGS. 11 and 12 correspond to the graphical representation representing in predetermined order a plurality of kinds of patient condition information classified as the same category by the classifier in the embodiment of the present invention.

Next, the second graphical representation will be described. An example of the second graphical representation is a scatter diagram with the horizontal axis representing the medicine taking amount and the vertical axis representing the blood pressure. From the distribution of the plots shown in the scatter diagram, the care concerned person can visually determine whether there is a correlation between the medicine taking amount and the blood pressure or not.

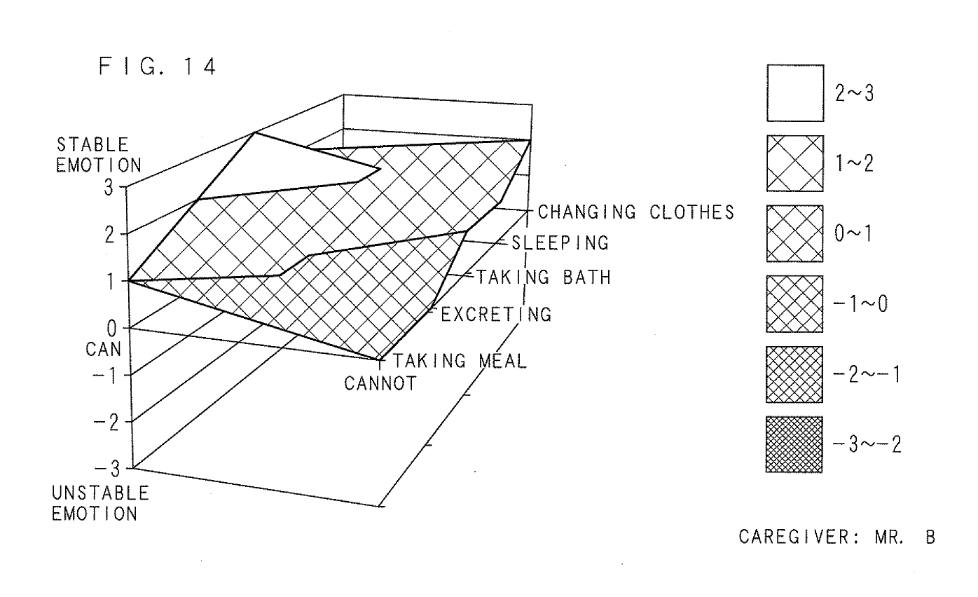

FIGS. 13 to 16 are schematic views showing an example of the second graphical representation included in the graphical representation output screen. FIGS. 13 and 14 are 3D area charts where regarding a plurality of kinds of everyday acts, whether the patient can perform the everyday acts or not is associated with the emotional stability of the patient. While the two 3D area charts shown in FIGS. 13 and 14 may be included in different graphical representation output screens, it is preferable that they be included in the same graphical representation output screen. This is because it is easy for the care concerned person to compare the pieces of patient condition information shown in the two 3D area charts with each other.

Now, questions and answers necessary for generating such 3D area charts will be described. First, the name of the caregiver in charge of the care of the patient is asked. The name of the caregiver is noted outside the 3D area chart. In the case of FIG. 13, the name of Mr. A is noted as the caregiver, whereas in the case of FIG. 14, the name of Mr. B is noted as the caregiver. Then, for each of five kinds of everyday acts of taking a meal, excreting, taking a bath, sleeping and changing clothes, it is asked whether the patient can perform the everyday act without any specific problem or not. For example, questions as to changing clothes include: can the patient choose clothes?; can the patient put on and take off a jacket?; can the patient put on and take off pants, shorts and the like?; can the patient put on shoes?; and can the patient fold clothes and put them in a predetermined place, and the answers to these questions are yes (can) and no (cannot).

Then, for each everyday act, the emotional stability of the patient in a case where the patient can perform the everyday act without any specific problem (hereinafter, referred to as a case where the patient can perform the everyday act) is asked. Further, whether the patient cannot do the everyday act at all or the emotional stability of the patient in a case where the patient cannot perform some part of the everyday act (hereinafter, referred to as a case where the patient cannot perform the everyday act) is asked. Here, the case where the patient cannot perform some part of the everyday act is, for example, a case where when taking a bath, the patient cannot get into a bathtub or soak in the hot water although the patient can wash his/her body and a case where regarding excreting, the patient neither plays with feces nor performs filthy acts although the patient sometimes excretes in places other than toilets.

The question as to the emotional stability is required to be answered by integers of six levels of “−3” to “3”. The stabler the emotion is, the higher the numerical value of the emotional stability is, and the more unstable the emotion is, the lower the numerical value of the emotional stability is. When Mr. A is in charge of care, the answerer answers that the emotional stability of the patient is “1” when the patient can take a meal and is “−3” when the patient cannot take a meal. On the other hand, when Mr. B is in charge of care, the answerer answers that the emotional stability of the patient is “1” when the patient can take a meal and is “0” when the patient cannot take a meal. For each of excreting, taking a bath, sleeping and changing clothes, the caregiver makes answers similarly to the case of taking a meal.

The present invention is not limited to the structure in which the emotional stability is inputted by the answerer. For example, a structure may be adopted in which for each of the cases where the patient can take a meal and where the patient cannot take a meal, the answerer answers the emotions of delight, anger, sorrow and pleasure exhibited by the patient and the strengths of the emotions. In this case, based on the answer content information representative of the emotions of delight, anger, sorrow and pleasure and the strengths of the emotions, the control unit 21 calculates the emotional stability, and stores the result of the calculation in the storage unit 23 as the patient condition information. Moreover, the question to ask the emotional stability is not limited to a question to ask the result of observation of the emotions exhibited by the patient in everyday acts. This may be, for example, a question to ask the result of observation of the emotion exhibited by the patient when the answerer asks the patient whether the patient can perform an everyday act or not and the patient answers the question.

The pieces of patient condition information representative of whether the patient can take a meal, excrete, take a bath, sleep and change clothes are classified as a category “everyday act”. In the 3D area charts shown in FIGS. 13 and 14, the X-axis represents the five kinds of everyday acts, the Y-axis represents whether the patient can perform the everyday acts or not, and the Z-axis represents the emotional stability. By looking at the 3D area chart shown in FIG. 13, it is found that the emotion of the patient is always unstable when the patient cannot perform the everyday acts. On the other hand, by looking at the 3D area chart shown in FIG. 14, it is found that the emotion of the patient is not unstable even when the patient cannot perform the everyday acts.

Moreover, by comparing the 3D area chart shown in FIG. 13 and the 3D area chart shown in FIG. 14, it is found that the emotion of the patient is generally stabler when Mr. B is in charge of care than when Mr. A is in charge of care. From this, it can be speculated that care by Mr. B is more suitable for this patient than care by Mr. A. When dementia is advanced, the number of everyday acts that the patient cannot do is increased. However, it is considered that even though the patient cannot do the everyday acts, the emotion can be maintained stable depending on the attitude of the caregiver toward the patient. That is, the 3D area chart shown in FIG. 14 shows a condition close to ideal. Therefore, the care concerned person viewing the 3D area chart show in FIG. 13 takes countermeasures so that the 3D area chart shown in FIG. 14 is outputted from the next time.

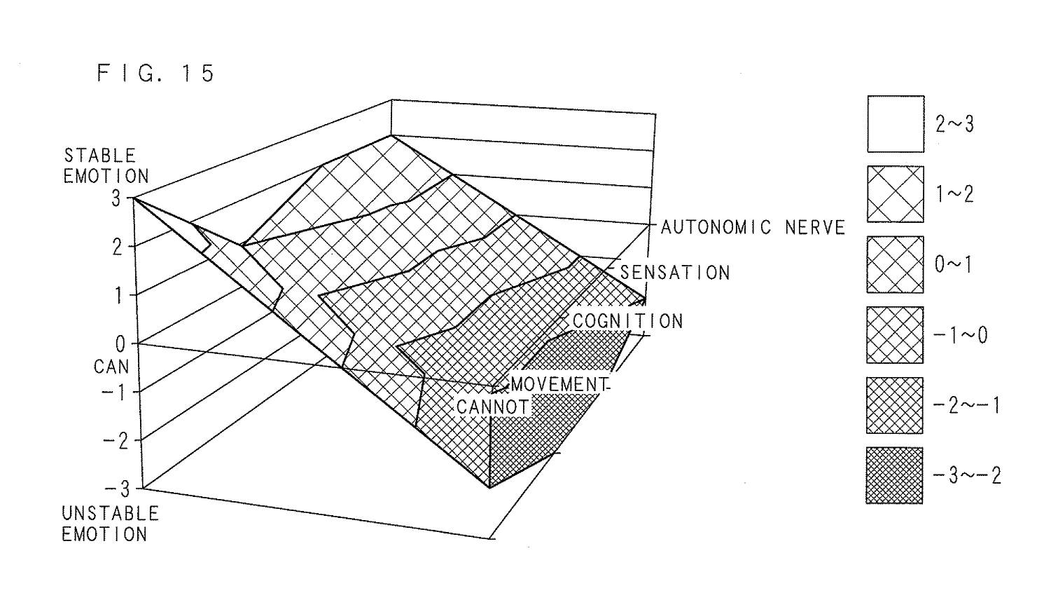

The graph shown in FIG. 15 is a 3D area chart in which whether movement is possible or not, whether cognition is possible or not, whether the sensation works or not and whether the autonomic nerve works or not are associated with the emotional stability of the patient. By looking at the 3D area chart shown in FIG. 15, it is found that the emotion is particularly unstable when the patient cannot recognize something and when the sensation of the patient does not work.

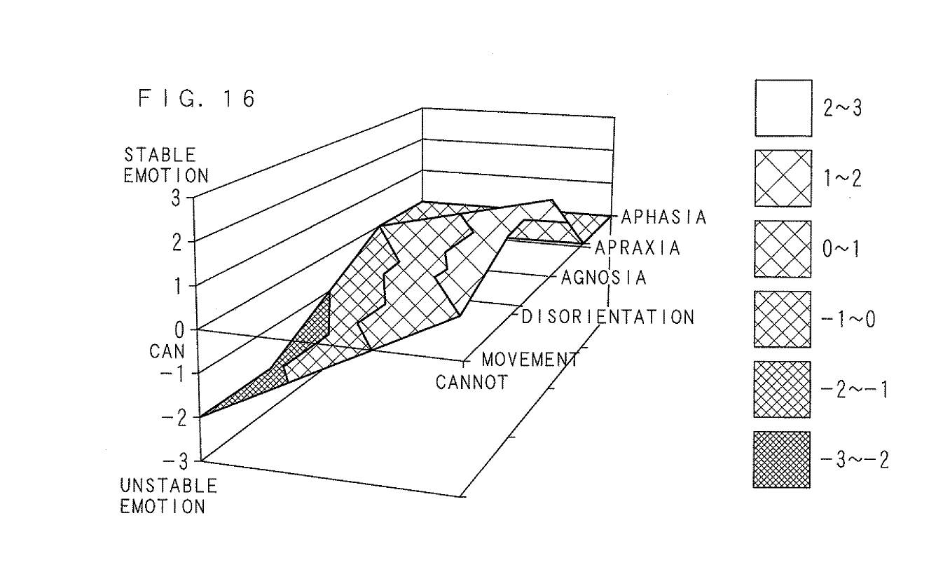

The graph shown in FIG. 16 is a 3D area chart in which whether the patient answered “yes” or “no” to a question whether the patient had a core symptom or not is associated with the emotional stability of the patient. By looking at the 3D area chart shown in FIG. 16, it is found that the emotion of the patient is somewhat unstable when the patient admits having amnesia, disorientation and agnosia.

The graphical representations shown in FIGS. 13 to 16 correspond to the graphical representation in which a plurality of kinds of patient condition information classified as the same category by the classifier in the embodiment of the present invention and other pieces of patient condition information stored in the information storage unit are associated with each other.

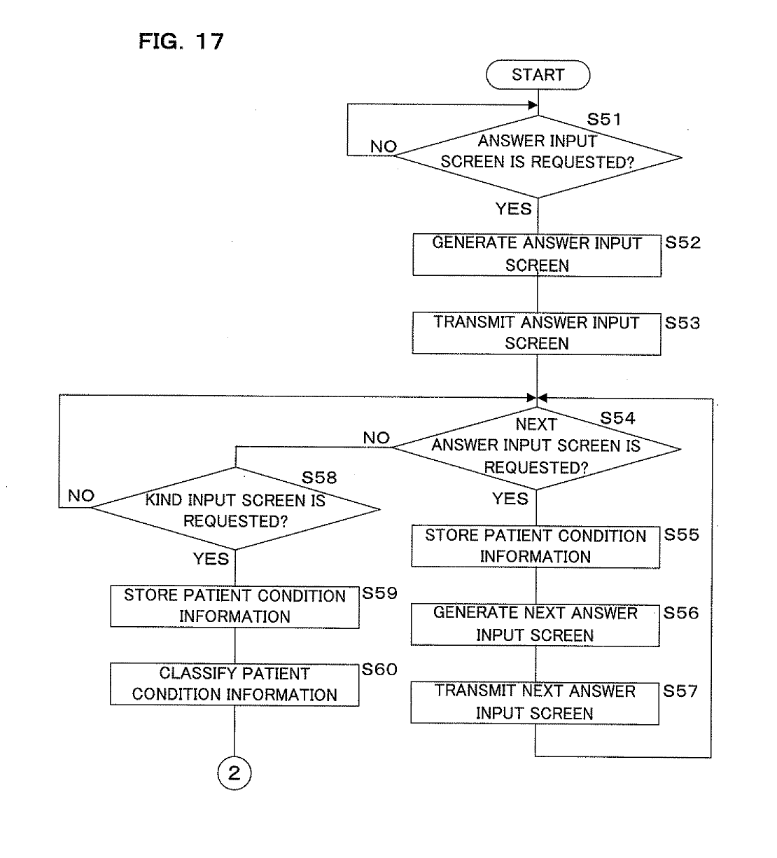

Lastly, referring to FIG. 5 and the following FIGS. 17 to 19, the graphical representation output processing executed by the server 2 will be described. In the following, communication between the server 2 and one PC 1 will be shown as an example. FIGS. 17 to 19 are flowcharts showing the procedure of the graphical representation output processing.

As shown in FIG. 17, the control unit 21 receives the patient ID, the answerer ID and the like inputted on the ID input screen, and determines whether the image data of the answer input screen is requested by the PC 1 or not (S51), and when the image data is not requested yet, the control unit 21 executes the processing of S51 again. When the image data of the answer input screen is requested, the control unit 21 temporarily stores in the RAM 22 the patient ID, the answer ID and the like received at S51, and then, generates the image data of the answer input screen (S52). The control unit 21 at S52 identifies the patient, for example, by searching the patient data by using the patient ID received at S51, and generates the image data of the answer input screen showing the name of the patient associated with the received patient ID.

At this time, the control unit 21 generates the image data of the answer input screen where the contents of the questions are shown based on the question content information, the answer acceptance information and the like with which the first presentation order information is associated in the question data and further, radio buttons, check buttons, text boxes and the like for inputting answers are provided. In the case of an answer selection type question, the control unit 21 selects an appropriate number of options according to the number of times of selection SS, and generates the image data of the answer input screen showing the contents of the selected options. Moreover, referring to the question kind flags, the control unit 21 generates the image data of the answer input screen in which, for example, in the case of a question to be answered only by the care concerned person, the answer space is provided only for the care concerned person and in the case of a question to be answered by both the care concerned person and the patient, the answer space is provided for both.

After the completion of the processing of S52, the control unit 21 transmits the generated image data of the answer input screen to the PC 1 (S53). Then, the control unit 21 receives the answer content information and the answer date, and determines whether the image data of the next answer input screen is requested by the PC 1 or not (S54).

When the image data of the next answer input screen is requested (YES at S54), the control unit 21 stores in the storage unit 23, as a part of the answer data, the patient condition information based on the answer content information received at S54 and the answer date together with the patient ID stored in the RAM 22 (S55). When the answer content information received at S54 represents an option, the control unit 21 at the processing of S55 also increments the number of times of selection SS in the question data. Then, the control unit 21 generates the image data of the next answer input screen (S56).

The control unit 21 at S56 selects the question content information whose order of presentation represented by the presentation order information is the highest in the question data. Alternatively, the control unit 21 selects the question content information associated with the patient ID stored in the RAM 22. Alternatively, the control unit 21 obtains the symptom represented by the patient condition information stored at S55, and selects the question content information associated with the patient condition information representative of the obtained symptom. In selecting the question content information, the question kind flags are referred to. Then, the control unit 21 at S56 generates the image data of the answer input screen based on the selected question content information, the question kind flags, the answer acceptance information and the like.

After the completion of the processing of S56, the control unit 21 transmits the generated image data of the answer input screen to the PC 1 (S57), and returns the process to S54. When the image data of the next answer input screen is not requested (NO at S54), the control unit 21 receives the answer content information and the answer date, and determines whether the image data of the kind input screen is requested by the PC 1 or not (S58). When the image data is not requested yet (NO at S58), the control unit 21 executes the processing of S54 again.

When the image data of the kind input screen is requested (YES at S58), the control unit 21 makes the patient condition information based on the answer content information received at S54 and the answer date the same as those in the processing of S55, and stores them in the storage unit 23 (S59). Then, the control unit 21 classifies the patient condition information stored in the storage unit 23 at S55 and S59 (S60). The control unit 21 at S60 associates the classification category information as the result of the classification with the patient condition information.

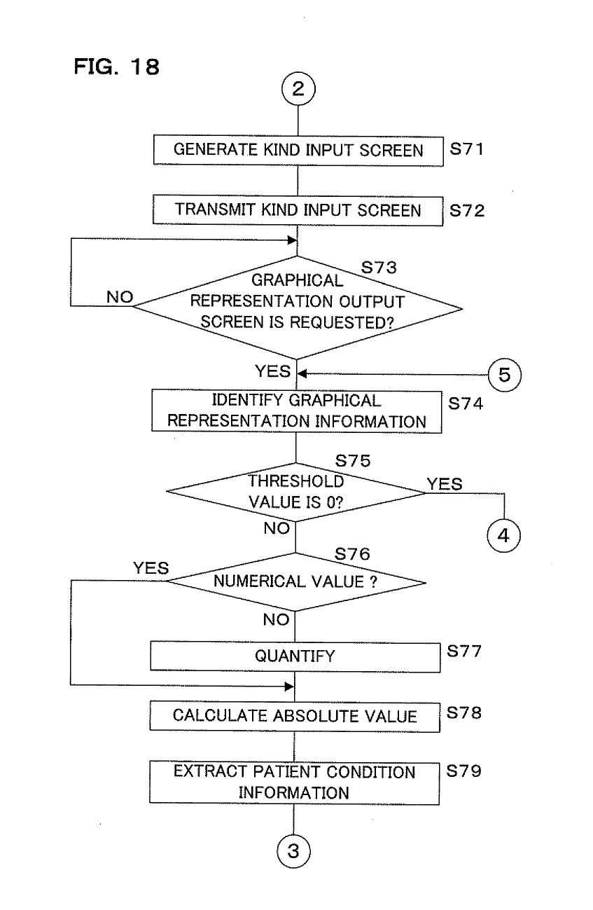

Then, as shown in FIG. 18, the control unit 21 generates the image data of the kind input screen (S71). The control unit 21 at S71 generates the image data of the kind input screen where a message to prompt the user to input the graphical representation kind information is shown and radio buttons, check buttons, text boxes and the like for inputting graphical representation kind information are provided. After the completion of the processing of S71, the control unit 21 transmits the generated image data of the kind input screen to the PC 1 (S72).

Then, the control unit 21 receives the graphical representation kind information, and determines whether the image data of the graphical representation output screen is requested by the PC 1 or not (S73), and when the image data is not requested yet (NO at S73), the control unit 21 executes the processing of S73 again. When the image data of the graphical representation output screen is requested (YES at S73), the control unit 21 identifies the pieces of information related to the graphical representation to be included in the graphical representation output screen, based on the graphical representation kind information received at S73 (S74).

For example, when the graphical representation kind information represents a cumulative bar graph showing the monthly changes of the medicine taking condition in the latest twelve months, the pieces of information identified at S74 are the category “medicine taking condition” as which the patient condition information to be shown in the graphical representation is classified, the patient condition information classified as this category (that is, the kind of medicine, the medicine taking timing, and the medicine taking amount), the specific contents of, of the patient condition information associated with the patient ID stored in the RAM 12, the kind of medicine, the medicine taking timing and the medicine taking amount in the latest twelve months, and the setting of each of the vertical and horizontal axes.

Moreover, when the graphical representation kind information represents a line graph showing the monthly changes of the biological information in the latest twelve months, the pieces of information identified at S74 are the category “body information” as which the patient condition information to be shown in the graphical representation is classified, the patient condition information classified as this category (that is, the systolic blood pressure, the diastolic blood pressure, the weight and the body temperature), the specific contents of, of the patient condition information associated with the patient ID stored in the RAM 12, the systolic blood pressure, the diastolic blood pressure, the weight and the body temperature in the latest twelve months, and the setting of each of the vertical and horizontal axes.

Further, when the graphical representation kind information represents a 3D area chart where whether the everyday acts are possible or not is associated with the emotional stability of the patient, the pieces of information identified at S74 are the category “everyday act” as which the patient condition information to be shown in the graphical representation is classified, the patient condition information classified as this category (that is, taking a meal, excreting, taking a bath, sleeping, and changing clothes), whether, of the patient condition information associated with the patient ID stored in the RAM 12, taking a meal, excreting, taking a bath, sleeping and changing clothes are possible or not, the emotional stability when the everyday acts are possible and the emotional stability when the everyday acts are impossible, and the setting of each of the X-axis, Y-axis and Z-axis.

After the completion of S74, the control unit 21 searches the threshold value data, and determines whether the threshold value associated with the patient condition information identified at S74 is “0” or not (S75). When the threshold value is higher than “0” (NO at S75), the control unit 21 determines whether the patient condition information identified at S74 is expressed as a numerical value or not (S76), and when the patient condition information is a non-numerical value (NO at S76), the control unit 21 quantifies the patient condition information by a predetermined procedure (S77).

After the completion of the processing of S77 or when the patient condition information identified at S74 is expressed as a numerical value (YES at

S76), the control unit 21 calculates the absolute value of the difference between two pieces of patient condition information (S78). Then, the control unit 21 extracts, of the patient condition information identified at S74, the patient condition information whose absolute value calculated at S78 is not less than the threshold value (S79). The control unit 21 at S78 calculates the absolute value of the difference between the previous month and the present month, for example, for each of the quantified medicine kind, the quantified medicine taking timing and the quantified medicine taking amount. At this time, the control unit 21 at S79 extracts without any condition the patient condition information that is absent in the previous month. For example, in the case of the graph shown in FIG. 10, the patient condition information in August is inevitably extracted.

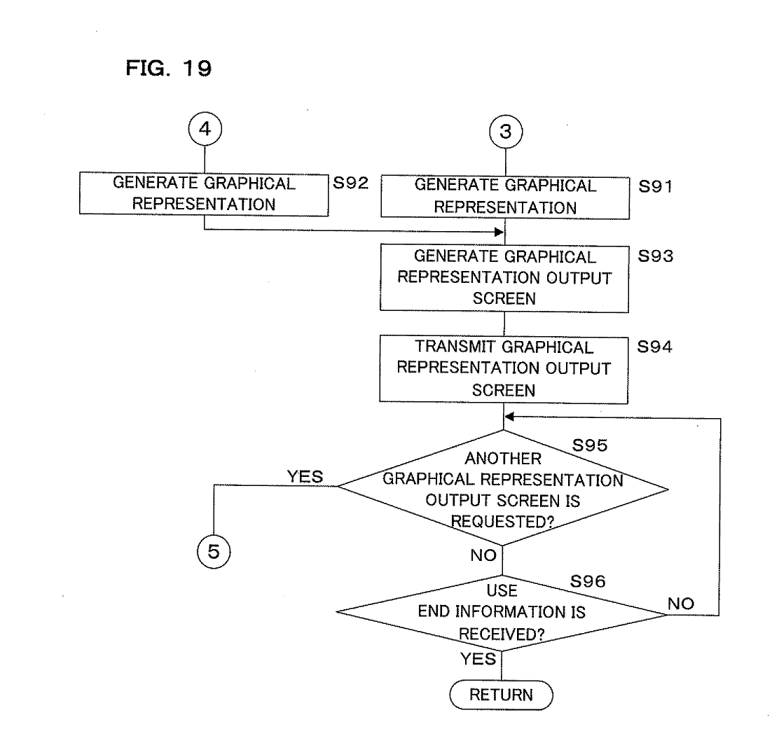

After the completion of the processing of S79, as shown in FIG. 19, the control unit 21 generates the graphical representation representing the patient condition information extracted at S79 (S91). On the other hand, as shown in FIG. 18, when the threshold value associated with the patient condition information identified at S74 is “0” (YES at S75), as shown in FIG. 19, the control unit 21 generates the graphical representation representing the patient condition information identified at S74 (S92).

After the completion of the processing of S91 or S92, the control unit 21 generates the image data of the graphical representation output screen (S93). The control unit 21 at S93 generates the image data of the graphical representation output screen where the graphical representation generated at S91 or S92 is shown and further, the information acceptor and the use end button are provided. This graphical representation output screen may include a countermeasure message. After the completion of the processing of S93, the control unit 21 transmits the generated image data of the graphical representation output screen to the PC 1 (S94).

Then, the control unit 21 receives the graphical representation kind information, and determines whether the image data of another graphical representation output screen is requested by the PC 1 or not (S95), and when the image data is requested (YES at S95), the control unit 21 shifts the process to S74, and identifies the pieces of information related to the graphical representation to be included in the graphical representation output screen, based on the graphical representation kind information received at S95. When the image data of another graphical representation output screen is not requested yet (NO at S95), the control unit 21 determines whether the use end information is received or not (S96), and when the image data is not received yet (NO at S96), the control unit 21 returns the process to S95. When the use end information is received (YES at S96), the control unit 21 temporarily finishes the graphical representation output processing, and returns the process to S51.

By the above-described graphical representation output processing being executed, the server 2 functions as the dementia information output apparatus in the embodiment of the present invention. The control unit 21 executing the processing of S60 functions as the classifier in the embodiment of the present invention. The control unit 21 executing the processing of S77 functions as the quantifier in the embodiment of the present invention. The control unit 21 executing the processing of S78 functions as the first difference calculator or the second difference calculator in the embodiment of the present invention. The control unit 21 executing the processing of S79 functions as the extractor in the embodiment of the present invention. The control unit 21 executing the processings of S91 and S92 functions as the first generator or the second generator in the embodiment of the present invention. The control unit 21 executing the processing of S93 functions as the graphical representation output unit in the embodiment of the present invention.

The dementia information output apparatus in the embodiment of the present invention may be structured by using a PC. In this case, the answerer inputs answers to the PC as the dementia information output apparatus. Moreover, on the display unit of this PC, a graphical representation output screen including the generated graphical representation is displayed. In this case, the dementia care support method in the embodiment of the present invention can be implemented without the PC and the server communicating with each other.

By using the dementia care support system 4 as described above, the care concerned person can view graphical representations of a wide variety of patient condition information such as the condition of the patient in daily life, the condition of the patient in a specific situation, the contents of meals, the contents of care, the medicine taking condition, the biological information or the score of the MMSE. By referring to the patient condition information converted into a graphical representation, the care concerned person can learn the everyday condition of the patient more easily than by referring to a care record over a long period of time. For this reason, the care concerned person can accurately determine the contents and degree of the symptoms of the patient and the contents and degree of the changes of the symptoms. The care concerned person can take appropriate countermeasures according to the symptoms of the patient and the changes of the symptoms based on the result of the determination.

Further, the dementia care support system 4 can be used at any place as long as the PC 1 can be installed. For this reason, the viewing, sharing and the like of the large amount of patient condition information stored in the dementia care support system 4 is easy. For example, the care concerned person can search for the causes of the changes of the symptoms of the patient. Moreover, it is possible to confirm the effect of the care, the treatment or the medication and reflect the result of the confirmation in the future care plan, treatment policy or medication policy. Further, by speculating the future changes of the symptoms, the dementia care support system 4 can be used for preventive care.

In the explanation given above, for simplicity, as the information inputted to the PC 1, the data stored in the storage unit 23 and the like, minimum ones are shown as an example. However, in actuality, it is desirable that a wider variety of information and data be used. For example, it is desirable that the patient data include basic information such as the name, age, address, family configuration and living condition of the patient, the dementia diagnosis examination taken by the patient and the result of the examination, the diagnosis by the doctor, and information on the medical history and medication history of the patient.

The dementia diagnosis examination is, for example, the dementia examination, the MRI (magnetic resonance imaging) examination, the SPECT (single photon emission computed tomography) examination, the blood examination, the electrocardiogram examination and the chest X-ray. Examples of the dementia examination include, in addition to the MMSE, the Japanese version of the RBMT (rivermead behavioral memory test) and the FAB (frontal assessment battery).

Questions presented by the dementia care support system 4 may include a question used for a known dementia examination. Moreover, the frequency and volume of urination, the frequency of defecation, the stool output, the hardness of stool and the like may be asked. A structure may be adopted in which when there is more than one core symptom corresponding to the degree of dementia progression of the patient, first, a typical question to determine the severest core symptom is asked, the severest core symptom is determined from the answer to this question and based on the result of the determination, a question as to the severest core symptom is asked.

Here, the typical question is, for example, a question to check whether the patient is responsible for the occurrence of the core symptom or not. At this time, a structure may be adopted in which when there is more than one cause of the occurrence of the core symptom, a question to determine which one is the cause of the occurrence of the core symptom of the patient is asked first, the cause of the occurrence of the core symptom is identified from the answer to this question, and based on the result of the identification, a question to check whether the patient is responsible for the occurrence of the core symptom or not is asked.

The “question to be answered only by the patient” referred to in the description of the question kind flags is, for example, a question to ask the patient's own name. Since the name of the patient is included in the patient data, the control unit 21 can determine the correctness or incorrectness of the answer of the patient. On the other hand, in the case of the question to be answered by both the care concerned person and the patient, the control unit 21 can determine the correctness or incorrectness of the answer of the patient by regarding the answer of the care concerned person as correct. When the answer of the patient is incorrect, the control unit 21 may preferentially convert the patient condition information related to the incorrect answer into a graphical representation.

Moreover, when an answer that the patient has a characteristic symptom is obtained to the question as to the symptom characteristic of a specific patient which question is referred to in the description of the question kind flags, the control unit 21 may preferentially convert the patient condition information related to this answer into a graphical representation.

While in the present embodiment, a mode has been shown in which the control unit 11 as the control center of the PC 1 and the control unit 21 as the control center of the server 2 implement the dementia care support method in the embodiment of the present invention according to the support application and the computer program 2P, respectively, the present invention is not limited thereto. For example, the PC 1 or the server 2 may have a dedicated arithmetic circuit that executes a part or all of the arithmetic processing according to the dementia care support method in the embodiment of the present invention.

The embodiment disclosed herein is to be considered as illustrative in all aspects and not restrictive. It is intended that the scope of the invention embraces not the meaning described above but the meaning equivalent to the claims and all changes that fall within metes and bounds of the claims.

Moreover, as long as the effects of the invention are produced, the PC 1, the dementia care support system 4 or the like may include a structural element not disclosed in the embodiment.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A dementia care support method for supporting care and treatment of a patient of dementia in a dementia information output apparatus that outputs patient condition information used for grasping a symptom of the patient and a change of the symptom, the method comprising the steps of:
storing a plurality of pieces and/or a plurality of kinds of patient condition information based on an answer to each of a plurality of kinds of questions related to the patient;
generating a graphical representation representing the stored plurality of pieces of patient condition information in predetermined order and/or a graphical representation representing the stored plurality of kinds of patient condition information so as to be associated with each other; and
outputting the generated graphical representation.

2. A dementia information output apparatus that outputs patient condition information used for grasping a symptom of a patient of dementia and a change of the symptom, the apparatus comprising:
an information storage unit that stores a plurality of pieces and/or a plurality of kinds of patient condition information;
a first generator that generates a graphical representation representing in predetermined order a plurality of pieces of patient condition information stored in the information storage unit;
a second generator that generates a graphical representation representing, so as to be associated with each other, a plurality of kinds of patient condition information stored in the information storage unit; and
a graphical representation output unit that outputs the graphical representation generated by the first and/or the second generator.

3. The dementia information output apparatus according to claim 2,
wherein the information storage unit stores a plurality of pieces and/or a plurality of kinds of patient condition information based on an answer to each of a plurality of kinds of questions related to the patient.

4. The dementia information output apparatus according to claim 2, further comprising:
a quantifier that quantifies, of the patient condition information stored in the information storage unit, non-numerical one of the patient condition information by a predetermined procedure;
a first difference calculator that obtains an absolute value of a difference between two pieces of patient condition information quantified by the quantifier;
a second difference calculator that obtains an absolute value of a difference between, of the patient condition information stored in the information storage unit, two pieces of patient condition information expressed as numerical values;
a threshold value storage unit that stores a threshold value that is not less than “0”; and
an extractor that extracts, of the patient condition information stored in the information storage unit, the patient condition information whose absolute value obtained by the first or the second difference calculator is not less than the threshold value stored in the threshold value storage unit,
wherein the first or the second generator generates a graphical representation representing the patient condition information extracted by the extractor.

5. The dementia information output apparatus according to claim 2, further comprising
a classifier that classifies as a predetermined category the patient condition information stored in the information storage unit;
wherein the first generator generates a graphical representation representing in predetermined order a plurality of kinds of patient condition information classified as the same category by the classifier.

6. The dementia information output apparatus according to claim 2, further comprising
a classifier that classifies as a predetermined category the patient condition information stored in the information storage unit,
wherein the second generator generates a graphical representation representing, so as to be associated with each other, each of a plurality of kinds of patient condition information classified as the same category by the classifier and another of patient condition information stored in the information storage unit.

7. The dementia information output apparatus according to claim 2,
wherein the patient condition information is based on an answer to a question including a plurality of options, and employs information represented by a selected option.

8. The dementia information output apparatus according to claim 2,
wherein the patient condition information employs text and/or a numerical value.

9. A dementia care support system for supporting care and treatment of a patient of dementia, the system comprising:
a dementia information output apparatus that outputs patient condition information used for grasping a symptom of the patient and a change of the symptom; and
a first and a second communication apparatus capable of communicating with the dementia information output apparatus,
wherein the first communication apparatus includes:
an acceptor that accepts an answer to each of a plurality of kinds of questions related to the patient; and
an answer output unit that outputs the accepted answer to the dementia information output apparatus,
wherein the dementia information output apparatus includes:
an information storage unit that stores a plurality of pieces and/or a plurality of kinds of patient condition information based on the inputted answer;
a first generator that generates a graphical representation representing in predetermined order a plurality of pieces of patient condition information stored in the information storage unit;
a second generator that generates a graphical representation representing, so as to be associated with each other, a plurality of kinds of patient condition information stored in the information storage unit; and
a graphical representation output unit that outputs the graphical representation generated by the first and/or the second generator to the second communication apparatus, and
wherein the second communication apparatus includes a display unit that displays the inputted graphical representation or a recording unit that records the inputted graphical representation on a recording sheet.

10. A non-transitory computer-readable recording medium storing a computer program to cause a computer, having an information storage unit that stores a plurality of pieces and/or a plurality of kinds of patient condition information used for grasping a symptom of a patient of dementia and a change of a symptom, to output the patient condition information, the computer program comprising:
a first generation step of causing the computer to generate a graphical representation representing in predetermined order a plurality of pieces of patient condition information stored in the information storage unit;
a second generation step of causing the computer to generate a graphical representation representing, so as to be associated with each other, a plurality of kinds of patient condition information stored in the information storage unit; and
a graphical representation output step of causing the computer to output the graphical representation generated at the first and/or the second generation step.
